(19) United States
(12) Patent Application Publication
(10) Pub. No.: US 2026/0073570 A1
(43) Pub. Date: Mar. 12, 2026

(54) 3D DATA TRANSMISSION DEVICE, 3D DATA TRANSMISSION METHOD, 3D DATA RECEPTION DEVICE, AND 3D DATA RECEPTION METHOD

(71) Applicant: LG Electronics Inc., Seoul (KR)

(72) Inventors: Yeojin YOON, Seoul (KR); Joohyung BYEON, Seoul (KR); Donggyu SIM, Seoul (KR)

(21) Appl. No.: 19/107,371

(22) PCT Filed: Sep. 20, 2023
(86) PCT No.: PCT/KR2023/014312

§ 371 Date: Feb. 27, 2025

(30) Foreign Application Priority Data
Sep. 20, 2022 (KR) 10-2022-0118861

(51) Int. Cl. G06T 9/00; G06T 15/04; G06T 17/20; H04N 19/597

(52) U.S. Cl. CPC G06T 9/001; G06T 15/04; G06T 17/20; H04N 19/597; G06T 2210/36

(57) ABSTRACT

A 3D data transmission method according to embodiments may comprise the steps of: encoding original mesh data; and transmitting a bitstream including the encoded mesh data and signaling information. A 3D data reception method according to embodiments may comprise the steps of: receiving a bitstream including encoded mesh data and signaling information; decoding the encoded data in the bitstream on the basis of the signaling information; and rendering the decoded mesh data.

### TECHNICAL FIELD

Embodiments provide a method for providing 3D content to provide a user with various services such as virtual reality (VR), augmented reality (AR), mixed reality (MR), and self-driving services.

### BACKGROUND ART

Point cloud data or mesh data in 3D content is a set of points in 3D space. However, it is difficult to create point cloud data or mesh data due to the large amount of points in 3D space.

In other words, a large throughput is required to transmit and receive 3D data with a considerable number of points, such as a point cloud or mesh data.

### DISCLOSURE

### Technical Problem

An object of the present disclosure is to provide an apparatus and method for efficiently transmitting and receiving mesh data to resolve the aforementioned issue.

Another object of the present disclosure is to provide an apparatus and method to address the latency and encoding/decoding complexity of mesh data.

Another object of the present disclosure is to provide a device and method for compressing and reconstructing mesh data per resolution.

Another object of the present disclosure is to provide a device and method for increasing the compression efficiency of mesh data by applying a zero run-length method when compressing or reconstructing mesh data per resolution.

Embodiments are not limited to the above-described objects, and the scope of the embodiments may be extended to other objects that can be inferred by those skilled in the art based on the entire contents of the present disclosure.

### Technical Solution

To achieve these objects and other advantages and in accordance with the purpose of the invention, as embodied and broadly described herein, a method of three-dimensional (3D) data may include encoding original mesh data, and transmitting a bitstream containing the encoded mesh data and signaling information.

According to embodiments, the encoding of the mesh data may include generating base mesh data by decimating the original mesh data and encoding the base mesh data, generating additional vertices by subdividing the decimated mesh data one or more times and determining one or more levels varying depending on the number of times of the subdivision, reconstructing the encoded base mesh data, generating displacement information based on the subdivided mesh data and the reconstructed base mesh data, encoding the displacement information, reconstructing the encoded displacement information, reconstructing mesh data based on the reconstructed base mesh data and the reconstructed displacement information, regenerating a texture map based on a texture map of the original mesh data and the reconstructed mesh data, and encoding the regenerated texture map.

According to embodiments, the encoding of the displacement information may include encoding the displacement information corresponding to at least one of the one or more levels using a 2D video codec.

According to embodiments, the encoding of the displacement information may include encoding the displacement information corresponding to at least one of the one or more levels using a zero run-length coding.

According to embodiments, the encoding of the displacement information may include packaging the displacement information in a plurality of frames corresponding to at least one of the one or more levels, and encoding the packaged displacement information using a zero run-length coding.

According to embodiments, the displacement information in the plurality of frames may be packaged using an interleaving method or a serial method based on a mapping relationship of vertices between the frames.

According to embodiments, the signaling information may include information related to the one or more levels or information related to the packaging of the displacement information in the plurality of frames.

According to embodiments, the one or more levels may be at least one level of detail (LoD) or at least one scalable LoD (sLoD).

According to embodiments, the at least one sLoD may be configured based on the at least one LoD, wherein a specific sLoD in the at least one sLoD may be mapped to one of the at least one LoD.

According to embodiments, the number of levels in the at least one sLOD may be different from the number of levels in the at least one LoD.

According to embodiments, the encoding of the texture map may include encoding the texture map corresponding to at least one of the one or more levels using a 2D video codec.

According to embodiments, a device for transmitting three-dimensional (3D) data may include an encoder configured to encode original mesh data, and a transmitter configured to transmit a bitstream containing the encoded mesh data and signaling information.

According to embodiments, the encoder may include a base mesh compressor configured to generate base mesh data by decimating the original mesh data and encode the base mesh data, a mesh subdivider configured to generate additional vertices by subdividing the decimated mesh data one or more times and to determine one or more levels varying depending on the number of times of the subdivision, a base mesh reconstructor configured to reconstruct the encoded base mesh data, a displacement information generator configured to generate displacement information based on the subdivided mesh data and the reconstructed base mesh data, a displacement information encoder configured to encode the displacement information, a displacement information reconstructor configured to reconstruct the encoded displacement information, a mesh reconstructor configured to reconstruct mesh data based on the reconstructed base mesh data and the reconstructed displacement information, a texture map generator configured to regenerate a texture map based on a texture map of the original mesh data and the reconstructed mesh data, and a texture map generator configured to encode the regenerated texture map.

According to embodiments, a method of receiving three-dimensional (3D) data may include receiving a bitstream containing encoded mesh data and signaling information, decoding the encoded mesh data in the bitstream based on the signaling information, and rendering the decoded mesh data.

According to embodiments, the decoding of the mesh data may include reconstructing base mesh data from the encoded mesh data, generating additional vertices by subdividing the reconstructed base mesh data one or more times and determining one or more levels based on the signaling information and the number of times of the subdivision, decoding and reconstructing displacement information from the encoded mesh data, reconstructing mesh data based on the subdivided base mesh data and the reconstructed displacement information, decoding and reconstructing a texture map from the encoded mesh data, and performing rendering based on the reconstructed mesh data and the reconstructed texture map.

### Advantageous Effects

According to embodiments, a 3D data transmission method, 3D data transmission device, 3D data reception method, and 3D data reception device may provide good-quality 3D services.

According to embodiments, a 3D data transmission method, 3D data transmission device, 3D data reception method, and 3D data reception device may achieve various video codec schemes.

According to embodiments, a 3D data transmission method, 3D data transmission device, 3D data reception method, and 3D data reception device may support universal 3D content, such as for autonomous driving services.

According to embodiments, a 3D data transmission method, 3D data transmission device, 3D data reception method, and 3D data reception device may perform scalable encoding and decoding on displacement information and/or a texture map included in the mesh data. Thereby, hierarchical encoding/decoding of the mesh data may be enabled and mesh content with optimal resolution and image quality may be selectively reconstructed and provided based on the network and reception environment.

According to embodiments, a 3D data transmission method, 3D data transmission device, 3D data reception method, and 3D data reception device may include one or more sub-bitstream sets with different resolutions and image quality through scalable encoding and decoding, thereby providing mesh content with different resolutions to a user and increasing the compression efficiency of the mesh data.

According to embodiments, a 3D data transmission method, 3D data transmission device, 3D data reception method, and 3D data reception device may apply scalable encoding and decoding to the displacement information and/or texture map included in mesh data, thereby reconstructing the mesh data up to an available level based on the performance or display characteristics of the receiver and the network environment.

According to embodiments, a 3D data transmission method, 3D data transmission device, 3D data reception method, and 3D data reception device may efficiently utilize given resources by appropriately distributing resources, by allowing users to specify different degrees of precision and levels of mesh data to be reconstructed depending on the importance and frequency of use of objects, and reconstructing each object at a desired level in representing multiple mesh data objects.

According to embodiments, a 3D data transmission method, 3D data transmission device, 3D data reception method, and 3D data reception device may enable mesh data to be utilized in a wider variety of network environments and applications, and may further expand the scope of utilization of mesh data by flexibly using the resources of the receiver.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. For a better understanding of various embodiments described below, reference should be made to the description of the following embodiments in connection with the accompanying drawings. The same reference numbers will be used throughout the drawings to refer to the same or like parts. In the drawings:

FIG. 1 illustrates a system for providing dynamic mesh content according to embodiments;

FIG. 2 illustrates a V-MESH compression method according to embodiments;

FIG. 3 illustrates pre-processing in V-MESH compression according to embodiments;

FIG. 4 illustrates a mid-edge subdivision method according to embodiments;

FIG. 5 illustrates a displacement generation process according to embodiments;

FIG. 6 illustrates an intra-frame encoding process for V-MESH data according to embodiments;

FIG. 7 illustrates an inter-frame encoding process for V-MESH data according to embodiments;

FIG. 8 illustrates a lifting transform process for displacements according to embodiments;

FIG. 9 illustrates a process of packing transform coefficients into a 2D image according to embodiments;

FIG. 10 illustrates an attribute transfer process in a V-MESH compression method according to embodiments;

FIG. 11 illustrates an intra-frame decoding process for V-MESH data according to embodiments;

FIG. 12 illustrates an inter-frame decoding process for V-MESH data according to embodiments;

FIG. 13 illustrates a mesh data transmission apparatus according to embodiments;

FIG. 14 illustrates a mesh data reception apparatus according to embodiments;

FIG. 15 illustrates a mesh data transmission device according to embodiments;

FIG. 16 is a diagram illustrating an example of zero run-length encoding according to embodiments;

FIG. 17 is a flowchart illustrating an example method of zero run-length encoding of transform coefficients according to embodiments;

FIG. 18 is a diagram illustrating an example of zero run-length encoding in a normal coordinate system according to embodiments;

FIG. 19 is a flowchart illustrating an example of zero run-length encoding of displacement vector transform coefficients of a normal component in a normal coordinate system according to embodiments;

FIG. 20 is a flowchart illustrating an example of zero run-length encoding of displacement vector transform coefficients of a tangential component in a normal coordinate system according to embodiments;

FIG. 21 illustrates an example of packing displacement vector transform coefficients of multiple frames in an interleaving manner according to embodiments;

FIG. 22 illustrates an example of packing displacement vector transform coefficients of multiple frames in a serial manner according to embodiments;

FIG. 23 illustrates an example of zero run-length encoding of displacement vector transform coefficients of two interleaved frames per LoD_level according to embodiments;

FIG. 24 is a diagram illustrating an example of texture color mapping by a texture map generator according to embodiments;

FIG. 25 illustrates examples of compressing a texture map generated per level using a scalable video codec according to embodiments;

FIG. 26 is a diagram illustrating a mesh data reception device according to embodiments;

FIG. 27-(a) is a flowchart illustrating an example of zero run-length decoding of displacement vector transform coefficients according to embodiments;

FIG. 27-(b) is a flowchart illustrating an example of decoding of the absolute values of displacement vector transform coefficients according to embodiments;

FIGS. 28-(a) and 28-(b) are flowcharts illustrating an example of zero run-length decoding of displacement vector transform coefficients of a normal component in a normal coordinate system according to embodiments;

FIGS. 29-(a) and 29-(b) are flowcharts illustrating an example of zero run-length decoding of displacement vector transform coefficients of tangential components in a normal coordinate system according to embodiments;

FIG. 30 is a flowchart illustrating entropy decoding of the absolute value abs(dispn) of the transform coefficients according to embodiments;

FIG. 31 is a flowchart illustrating an example method of decoding transform coefficients of multiple frames according to embodiments;

FIG. 32 is a flowchart illustrating another example method of decoding transform coefficients of multiple frames according to embodiments;

FIG. 33 is a diagram illustrating an example of scalable decoding of a texture map by a texture map decoder according to embodiments;

FIG. 34 illustrates an example syntax structure of LoD-related information (LoD_Info ( ) in signaling information according to embodiments;

FIG. 35 illustrates an example syntax structure of displacement vector decoding related information (Decode_Disp ( ) in signaling information according to embodiments;

FIG. 36 illustrates an example syntax structure of information related to decoding of displacement vector transform coefficients (decode_displacement_coefficient ( ) in signaling information according to embodiments;

FIG. 37 illustrates an example syntax structure of packing related information for multiple frames (unpack_displacemenst_for_multiframe ( ) in signaling information according to embodiments;

FIG. 38 is a flowchart illustrating an example transmission method according to embodiments; and

FIG. 39 is a flowchart illustrating an example reception method according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

With recent advancements in 3D data modeling and rendering technologies, research on generating and processing 3D data has been actively conducted across various fields, including virtual reality (VR), augmented reality (AR), autonomous driving, computer-aided design (CAD)/computer-aided manufacturing (CAM), and geographic information systems (GIS). 3D data may be represented as a point cloud or a mesh depending on the representation format. A mesh is composed of geometry information indicating the coordinates of each vertex or point, connectivity information indicating connections between vertices, a texture map representing color information about the mesh surface as 2D image data, and texture coordinates indicating the mapping information between the surface of the mesh and the texture map. In the present disclosure, a mesh is defined as a dynamic mesh when at least one of the elements constituting the mesh changes over time, and is defined as a static mesh when it does not change.

Dynamic mesh data involves significantly larger amounts of data of elements to represent the mesh compared to 2D image data. As a result, techniques for efficiently compressing a large amount of mesh data have been developed to store and transmit the data.

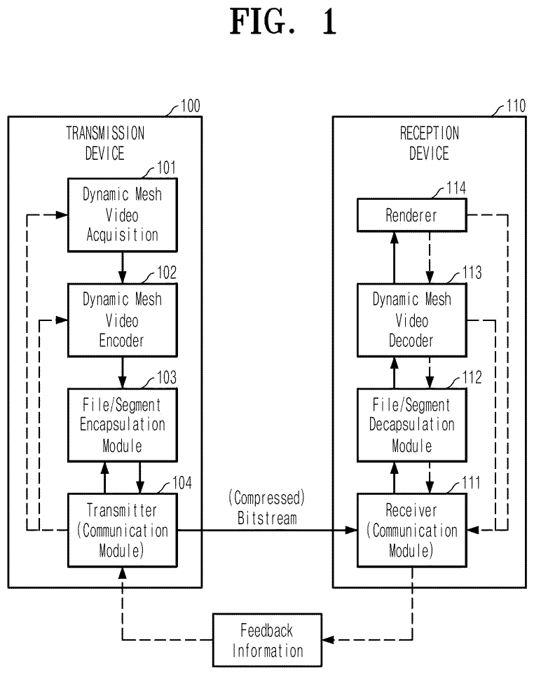

FIG. 1 illustrates a system for providing dynamic mesh content according to embodiments.

The system in FIG. 1 includes a transmission apparatus 100 and a reception apparatus 110. The transmission apparatus 100 may include a mesh video acquisition unit (or part) 101, a mesh video encoder 102, a file/segment encapsulator 103, and a transmitter 104. The reception apparatus 110 may include a receiver 111, a file/segment decapsulator 112, a mesh video decoder 113, and a renderer 114. Each component in FIG. 1 may correspond to hardware, software, a processor, and/or a combination thereof. In the following description, a mesh data transmission apparatus according to embodiments may be interpreted as referring to a 3D data transmission apparatus or transmission apparatus 100, or as referring to a mesh video encoder (hereinafter, encoder) 102. A mesh data reception apparatus according to embodiments may be interpreted as referring to a 3D data reception apparatus or reception apparatus 110, or as referring to a mesh video decoder (hereinafter, decoder) 113.

The system of FIG. 1 may perform video-based dynamic mesh compression and decompression.

With advancements in 3D capture, modeling, and rendering, users are allowed to access 3D content in various forms, such as AR, XR, metaverse, and holograms, across multiple platforms and devices. 3D content is increasingly becoming sophisticated and realistic in its representation of objects to provide immersive experiences for users. However, this requires a substantial amount of data for generation and use of 3D models. Among the various types of 3D content, 3D meshes are widely used for efficient data utilization and realistic object representation. Embodiments include a series of processing steps in a system that uses mesh content.

First, the method of compressing dynamic mesh data starts with the Video-based point cloud compression (V-PCC) standard technique for point cloud data. Point cloud data is data that has color information in the coordinates (X, Y, Z) of vertices (or points). In the present disclosure, vertex coordinates (i.e., position information) are referred to as geometry information, color information about vertices is referred to as attribute information. The geometry information and attribute information are together referred to as vertex information or point cloud data. Mesh data refers to vertex information including inter-vertex connectivity information. Content may be originally created in the form of mesh data. Alternatively, connectivity information may be added to point cloud data, and the point cloud data may be transformed into mesh data.

Currently, the MPEG standards group defines two data types for dynamic mesh data: Category 1 of mesh data having a texture map as color information, and Category 2 of mesh data having vertex colors as color information.

Mesh coding standards for Category 1 data are currently underway, and standardization for Category 2 data is expected to follow. The overall process for providing a mesh content service may include acquisition, encoding, transmission, decoding, rendering, and/or feedback processes, as shown in FIG. 1.

To provide mesh content services, 3D data acquired through multiple cameras or special cameras may be processed into a mesh data type through a series of steps to generate a video. The generated mesh video may be transmitted through a series of operations, and the receiving side may process the received data back into a mesh video for rendering. Through this process, the mesh video may be provided to the user, allowing the user to utilize the mesh content interactively according to their intent.

As shown in FIG. 1, a mesh compression system may include a transmission apparatus 100 and a reception apparatus 110. The transmission apparatus 100 may encode the mesh video to output a bitstream, which may be delivered to the reception apparatus 110 over a digital storage medium or a network in the form of file or streaming (streaming segments). The digital storage medium may include various storage media such as USB, SD, CD, DVD, Blu-ray, HDD, and SSD.

In the transmission apparatus 100, the encoder may be referred to as a mesh video/image/picture/frame encoding device. In the reception apparatus 110, the decoder may be referred to as a mesh video/image/picture/frame decoding device. A transmitter may be included in the mesh video encoder, and a receiver may be included in the mesh video decoder. The renderer 114 may include a display, and the renderer and/or display may be configured as separate devices or external components. The transmission apparatus 100 and reception apparatus 110 may further include separate internal or external modules/units/components for the feedback process.

Mesh data represents the surface of an object using multiple polygons. Each polygon is defined by vertices in 3D space and connectivity information indicating how the vertices are connected. Additionally, vertex attributes such as color and normal vectors may be included in the data. Mapping information, which allows the surface of the mesh to be mapped onto a 2D plane, may also be included in the attributes of the mesh. The mapping is generally described using a set of parametric coordinate related to mesh vertices, referred to as UV coordinates or texture coordinates, related to related to the vertices of the mesh. A mesh contains a 2D attribute map, which may be used to store high-resolution attribute information such as texture, normal, and displacement. Here, the displacement may be used interchangeably with displacement information or a displacement vector.

The mesh video acquisition unit 101 may include processing 3D object data acquired through a camera or the like into a mesh data type having the attributes described above through a series of operations and generating a video composed of the mesh data. In the mesh video, the attributes of the mesh, such as vertices, polygons, connectivity between vertices, color, and normal, may change over time. A mesh video with attributes and connectivity information that change over time is referred to as a dynamic mesh video.

The mesh video encoder 102 may encode an input mesh video into one or more video streams. A video may contain multiple frames, each of which may correspond to a still image/picture. In the present disclosure, the mesh video may include mesh images/frames/pictures. The term “mesh video” may be used interchangeably with mesh images/frames/pictures. The mesh video encoder 102 may perform a Video-based Dynamic Mesh (V-Mesh) compression procedure. For compression and coding efficiency, the mesh video encoder 102 may perform a series of procedures such as prediction, transformation, quantization, and entropy coding. Encoded data (encoded video/image information) may be output in the form of a bitstream.

The file/segment encapsulation module 103 may encapsulate encoded mesh video data and/or mesh video-related metadata in the form of a file or the like. The mesh video-related metadata may be received from a metadata processor. The metadata processing unit may be included in the mesh video encoder 102, or may be configured as a separate component/module. The file/segment encapsulation module 103 may encapsulate the data into a file format such as ISOBMFF or process the same into forms such as DASH segments. According to embodiments, the file/segment encapsulator 103 may include the mesh video-related metadata in the file format. For example, the mesh video metadata may be included in boxes at various levels in the ISOBMFF file format, or as data on separate tracks in the file. In some embodiments, the file/segment encapsulator 103 may encapsulate the mesh video-related metadata into a file.

The transmission processor may apply processing to the encapsulated mesh video data for transmission based on the file format. The transmission processor may be included in the transmitter 104 or implemented as a separate component/module. The transmission processor may process the mesh video data according to any transmission protocol. The processing for transmission may include processing for delivery over a broadcast network and processing for delivery over a broadband. In some embodiments, the transmission processor may receive mesh video-related metadata from the metadata processor, as well as the mesh video data, and process the same for transmission.

The transmitter 104 may transmit the encoded video/image information or data output in bitstream form to the receiver 111 of the reception apparatus 110 over a digital storage medium or network in the form of a file or streaming. The digital storage medium may include various storage media such as USB, SD, CD, DVD, Blu-ray, HDD, and SSD. The transmitter 104 may include an element to generate a media file through a predetermined file format, and may include an element for transmission over a broadcast/communication network. The receiver 111 may extract the bitstream and deliver the same to a decoding device.

The receiver 111 may receive the mesh video data transmitted by the mesh data transmission apparatus. Depending on the channel for transmission, the receiver 111 may receive the mesh video data over a broadcast network or a broadband network, or may receive the mesh video data over a digital storage medium.

The reception processor may perform processing on the received mesh video data according to the transmission protocol. The reception processor may be included in the receiver 111, or may be configured as a separate component/module. To correspond to the processing performed for transmission on the transmitting side, the reception processor may perform the reverse process to the operations of the transmission processor described above. The reception processor may deliver the acquired mesh video data to the file/segment decapsulator 112 and the acquired mesh video-related metadata to the metadata parser. The mesh video-related metadata acquired by the reception processor may be in the form of a signaling table.

The file/segment decapsulator 112 may decapsulate mesh video data in the form of files received from the reception processor. The file/segment decapsulator 112 may decapsulate the files according to ISOBMFF or the like to acquire a mesh video bitstream or mesh video-related metadata (metadata bitstream). The acquired mesh video bitstream may be delivered to the mesh video decoder 113, and the acquired mesh video-related metadata (metadata bitstream) may be delivered to the metadata processor. The mesh video bitstream may include metadata (metadata bitstream). The metadata processor may be included in the mesh video decoder 113, or may be configured as a separate component/module. The mesh video-related metadata acquired by the file/segment decapsulator 112 may be in the form of boxes or tracks in the file format. The file/segment decapsulator 112 may receive metadata required for decapsulation from the metadata processor, when necessary. The mesh video-related metadata may be delivered to the mesh video decoder 113 for use in the mesh video decoding procedure, or to the renderer 114 for use in the mesh video rendering procedure.

The mesh video decoder 113 may receive the input bitstream and perform the reverse operation corresponding to the operation of the mesh video encoder 102 to decode the video/images. The decoded mesh video/images may be displayed through the display of the renderer 114. The user may view all or a portion of the rendered result through a VR/AR display, a general display, or the like.

The feedback process may include transmitting various kinds of feedback information that may be acquired during the rendering/display operation to the transmitting side or to the decoder on the receiving side. The feedback process may provide interactivity in consuming the mesh video. In some embodiments, the feedback process may include transmitting head orientation information, viewport information indicative of an area the user is currently viewing, and the like. In some embodiments, the user may interact with objects implemented in the VR/AR/MR/autonomous driving environment. In this case, the information related to the interaction may be delivered to the transmitting side or service provider during the feedback process. In some embodiments, the feedback process may be skipped.

The head orientation information may refer to information about the user's head position, angle, movement, etc. Based on this information, information about the area that the user is currently viewing within the mesh video, i.e., viewport information, may be calculated.

The viewport information may be information about the area in the mesh video that the user is currently viewing. Gaze analysis may be performed based on this information to determine how the user consumes the mesh video, how long the user is looking at a particular area of the mesh video, and the like. The gaze analysis may be performed on the receiving side and the result may be delivered to the transmitting side through a feedback channel. A device, such as a VR/AR/MR display, may extract a viewport area based on the user's head position/orientation, the vertical or horizontal FOV supported by the device, etc.

In some embodiments, the feedback information described above may not only be delivered to the transmitter, but may also be consumed on the receiving side. In other words, operations such as decoding and rendering may be performed on the receiving side based on the feedback information described above. For example, based on the head orientation information and/or viewport information, only the mesh video for the area currently being viewed by the user may be preferentially decoded and rendered.

The present disclosure relates to embodiments of dynamic mesh video compression as described above. The methods/embodiments disclosed herein may be applied to the standard of Video-based Dynamic mesh compression (V-Mesh) of the Moving Picture Experts Group (MPEG) or any next-generation video/image coding standard. Dynamic mesh video compression is a method for processing mesh connectivity information and attributes that change over time. It may perform lossy and lossless compression for a variety of applications such as real-time communications, storage, free-viewpoint video, and AR/VR.

The dynamic mesh video compression method described below is based on the V-mesh method of the MPEG.

In the present disclosure, a picture/frame may generally refer to a unit that represents one image at a specific time.

A pixel or pel may refer to the smallest unit that constitutes a picture (or video). Additionally, the term “sample” may be used as a term corresponding to a pixel. A sample may generally indicate a pixel or the value of the pixel in general. It may indicate only the pixel/pixel value of the luma component, or may indicate only the pixel/pixel value of the chroma component, or may indicate only the pixel/pixel value of the depth component.

A unit may represent the basic unit of image processing. The unit may include at least one of a specific area of the picture and information related to the region. In some cases, the term unit may be used interchangeably with terms such as block or area. In general, an M×N block may include a set (or array) of samples (or a sample array) or transform coefficients composed of M columns and N rows.

As described above, the encoding process of FIG. 1 is performed as follows.

In other words, the compression method of Video-based dynamic mesh compression (V-Mesh) may provide a method of compressing dynamic mesh video data based on 2D video codecs such as High Efficiency Video Coding (HEVC) and Versatile Video Coding (VVC). In the V-Mesh compression process, the following data is received as input and compressed.

Input mesh: Includes 3D coordinates of the vertices comprising the mesh, normal information about each vertex, mapping information for mapping the surface of the mesh to a 2D plane, and connectivity between the vertices constituting the surface. The surface of the mesh may be represented by triangles or other polygons, and the connectivity information between the vertices constituting the surface is stored according to a predetermined shape. The input mesh may be stored in the OBJ file format.

Attribute map (Texture map is also used interchangeably hereafter): Contains information about the attributes (color, normals, displacements, etc.) of a mesh and stores the data in the form of a mapping of the surface of the mesh onto a 2D image. Mapping indicating which part (surface or vertex) of the mesh corresponds to each piece of data in the attribute map is based on the mapping information contained in the input mesh. Since the attribute map has data about each frame of the mesh video, it may also be referred to as an attribute map video. The attribute map in the V-Mesh compression method mainly contains the color information about the mesh and is stored in an image file format (PNG, BMP, etc.).

Material library file: Contains the material attribute information used in the mesh, specifically the information that links the input mesh to the corresponding attribute map. It is stored in the Wavefront Material Template Library (MTL) file format.

In the V-Mesh compression method, the following data and information may be generated through the compression process.

Base mesh: Represents the objects in the input mesh using the minimum vertices determined according to the user's criteria by decimating the input mesh through the pre-processing process.

Displacement: Displacement information used to represent the input mesh as similarly as possible using the base mesh, expressed in 3D coordinates.

Atlas information: Metadata needed to reconstruct a mesh using the base mesh, displacement, and attribute map information. It may be generated and utilized in sub-units (sub-mesh, patch, etc.) that constitute the mesh.

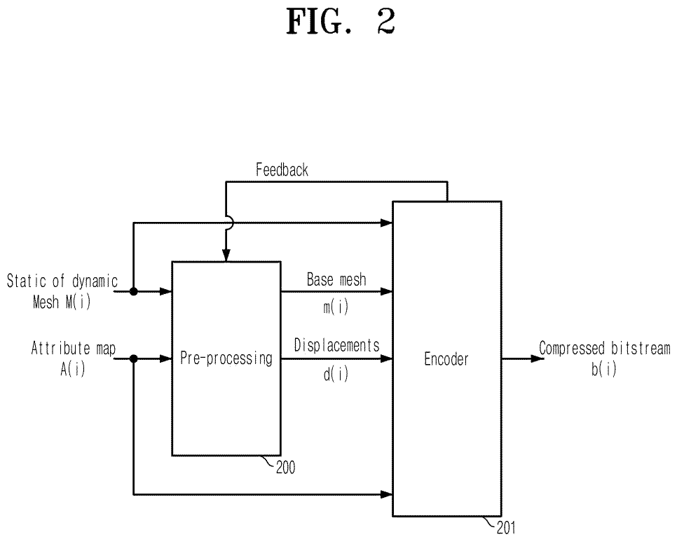

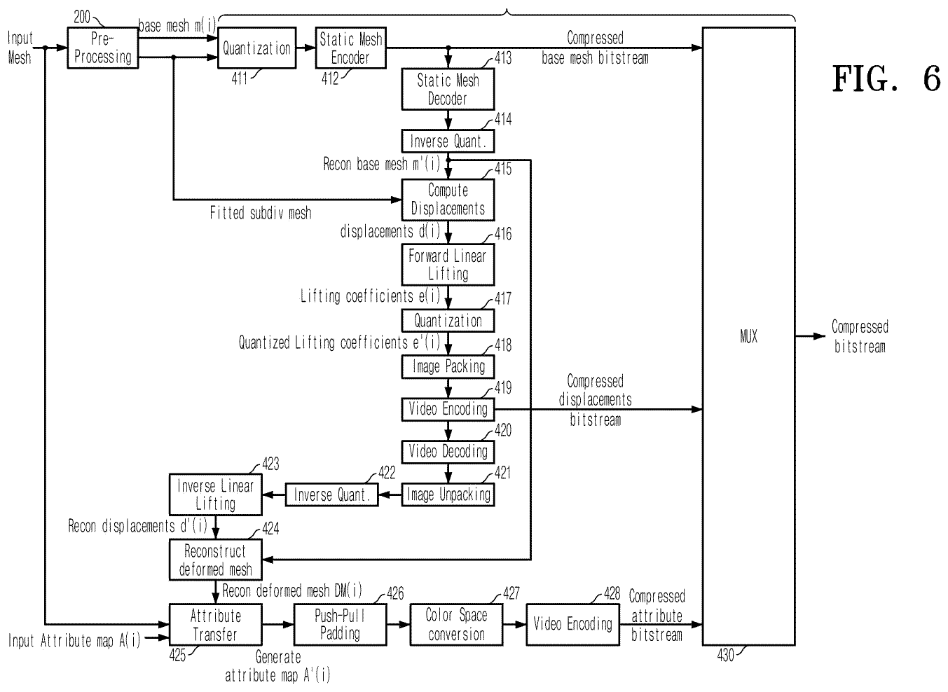

A method of encoding mesh position information (or vertex position information) is described with reference to FIGS. 2 to 7, and a method of reconstructing mesh position information to encode attribute information (attribute map) is described with reference to FIGS. 6 to 10 and the like.

FIG. 2 illustrates a V-MESH compression method according to embodiments.

FIG. 2 illustrates the encoding process of FIG. 1, wherein the encoding process may include a pre-processing process and an encoding process. The mesh video encoder 102 of FIG. 1 may include a pre-processor 200 and an encoder 201, as shown in FIG. 2. Also, the transmission apparatus of FIG. 1 may be broadly referred to as an encoder, and the mesh video encoder 102 of FIG. 1 may be referred to as an encoder. The V-Mesh compression method may include pre-processing 200 and encoding 201, as shown in FIG. 2. The pre-processor 200 of FIG. 2 may be positioned at the front end of the encoder 201 of FIG. 2. The pre-processor 200 and encoder 201 of FIG. 2 may be referred to as a single encoder.

The pre-processor 200 may receive a static of dynamic mesh (M (i)) and/or an attribute map (A (i)). The pre-processor 200 may generate a base mesh m (i) and/or displacements d (i) through pre-processing. The pre-processor 200 may receive feedback information from the encoder 201, and may generate the base mesh and/or displacements based on the feedback information.

The encoder 201 may receive the base mesh m (i), the displacements d (i), the static of dynamic mesh M (i), and/or the attribute map A (i). In the present disclosure, at least one of the base mesh m (i), the displacements d (i), the static of dynamic mesh M (i), and/or the attribute map A (i) may be referred to herein as mesh-related data. The encoder 201 may encode the mesh-related data to generate a compressed bitstream.

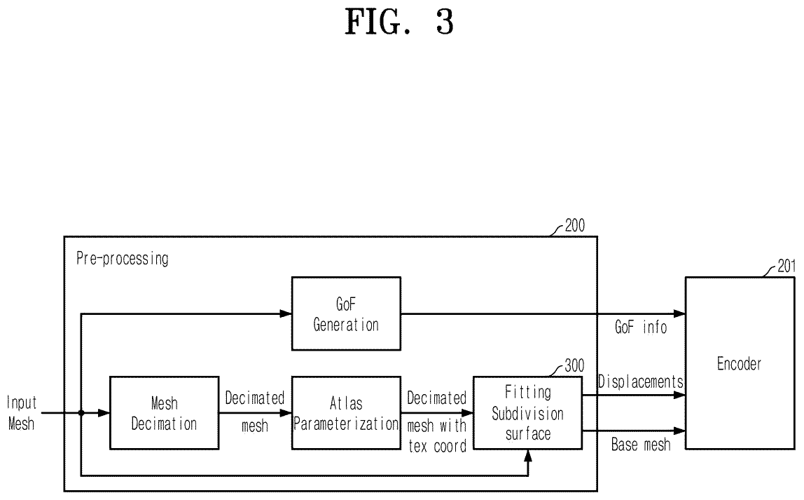

FIG. 3 illustrates pre-processing in V-MESH compression according to embodiments.

FIG. 3 illustrates the configuration and operation of the pre-processor of FIG. 2. In FIG. 3, the input mesh may include a static of dynamic mesh M (i) and/or attribute map A (i). The input mesh may also include 3D coordinates of vertices constituting the mesh, normal information about each vertex, mapping information for mapping the mesh surface to a 2D plane, and connectivity information between the vertices constituting the surface.

FIG. 3 illustrates the process of performing pre-processing on the input mesh. The pre-processing 200 may include four operations: 1) Group of Frame (GoF) generation, 2) mesh decimation, 3) UV parameterization, and 4) fitting subdivision surface (300). According to embodiments, the GoF generation may be referred to as a GoF generation process or a GoF generator, the mesh decimation may be referred to as a mesh simplification process or the mesh decimation part, the UV parameterization may be referred to as a UV parameterization process or the UV parameterization part, and the fitting subdivision surface may be referred to as a fitting subdivision surface process or a fitting subdivision surface part. The pre-processor 200 may generate displacements and/or a base mesh from the received input mesh, and deliver the same to the encoder 201. The pre-processor 200 may deliver GoF information related to the GoF generation to the encoder 201.

Hereinafter, each operation of FIG. 3 is described.

GoF generation: A process of generating a reference structure for the mesh data. When the mesh of the previous frame and the current mesh have the same number of vertices, same number of texture coordinates, same vertex connectivity information, and same texture coordinate connectivity information, the previous frame may be set as a reference frame. In other words, if only the vertex coordinate values are different between the current input mesh and the reference input mesh, the encoder 201 may perform inter frame encoding. Otherwise, it performs intra frame encoding for the frame.

Mesh decimation: A process of simplifying the input mesh to create a simplified mesh, called a base mesh. Vertices to remove may be selected from the original mesh based on user-defined criteria, and then the selected vertices and the triangles connected to the selected vertices may be removed.

In the process of performing mesh decimation, the voxelized input mesh, target triangle ratio (TTR), and minimum triangle component (CCCount) information may be delivered as input, and the decimated mesh may be obtained as output. In the process, connected triangle components that are smaller than the set minimum triangle component (CCCount) may be removed.

UV parameterization: A process of mapping a 3D curved surface into a texture domain for the decimated mesh. Parameterization may be performed using the UVAtlas tool. This process generates mapping information indicating where each vertex of the decimated mesh may be mapped to on the 2D image. The mapping information is expressed and stored as texture coordinates, and the final base mesh is generated through this process.

Fitting subdivision surface (300): A process of performing subdivision on the decimated mesh (i.e., a decimated mesh with texture coordinates). The displacements and base mesh generated by this process are output to the encoder 201. A user-defined method, such as the mid-edge method, may be applied as the subdivision method. A fitting process is performed such that the input mesh and the subdivided mesh become similar to each other. The mesh on which the fitting process is performed will be referred to herein as the fitted subdivided mesh.

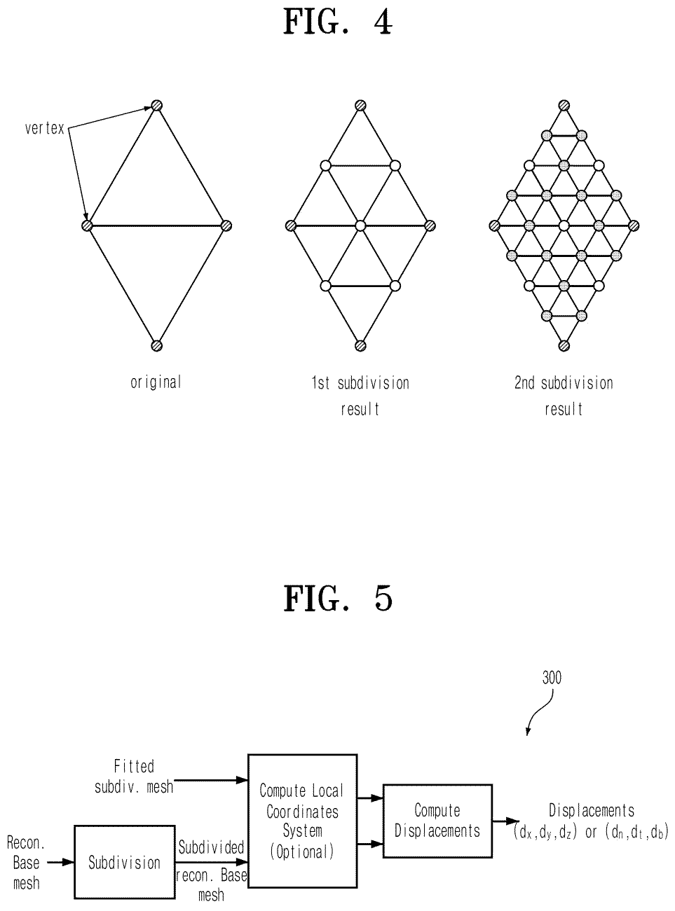

FIG. 4 illustrates a mid-edge subdivision method according to embodiments.

FIG. 4 illustrates a mid-edge subdivision method for the fitting subdivision surface described with reference to FIG. 3. Referring to FIG. 4, the original mesh containing four vertices is subdivided to create sub-meshes. The sub-meshes may be created by creating new vertices in the middle of the edges between the vertices. Then, the fitting process is performed to make the input mesh and the sub-mesh similar to each other, resulting in a fitted subdivided mesh.

Once the fitted subdivided mesh is generated, the displacements are calculated based on this result and the previously compressed and decoded base mesh (hereinafter referred to as the reconstructed base mesh). In other words, the reconstructed base mesh is subdivided in the same way as the fitting subdivision surface. The difference in position between this result and each vertex in the fitted subdivided mesh is the displacement for each vertex. Since the displacement represents a difference in position in 3D space, it is expressed as values in (x, y, z) space in the Cartesian coordinate system. Depending on a user input parameter, the coordinate values of (x, y, z) may be converted to coordinate values of (normal, tangential, bi-tangential) in a local coordinate system.

FIG. 5 illustrates a displacement generation process according to embodiments. The displacement generation process of FIG. 5 may be performed by the pre-processor 200, or may be performed by the encoder 201.

FIG. 5 illustrates in detail how displacements are calculated for the fitting subdivision surface 300, as described with reference to FIG. 4.

The encoder and/or pre-processor according to the embodiments may include 1) a subdivider, 2) a local coordinate system calculator, and 3) a displacement vector calculator. The subdivider may perform a subdivision on the reconstructed base mesh to generate a subdivided reconstructed base mesh. Here, the reconstruction of the base mesh may be performed by the pre-processor 200, or may be performed by the encoder 201. The local coordinate system calculator may receive the fitted subdivided mesh and the subdivided reconstructed base mesh, and may transform the coordinate system related to the mesh to a local coordinate system based on the received meshes. The local coordinate system calculation may be optional. The displacement calculator calculates the difference in position between the fitted subdivision mesh and the subdivided reconstructed base mesh. For example, it may generate the difference in position between the vertices in the two input meshes. The difference in position between the vertices is the displacement.

The mesh data transmission method and apparatus according to embodiments may encode the mesh data as follows. Mesh data is a term that includes point cloud data. Point cloud data (which may be referred to as a point cloud for short) according to embodiments may refer to data including vertex coordinates (also referred to as geometry information) and color information (also referred to as attribute information). In addition, a geometry image, an attribute image, an occupancy map, and auxiliary information (also referred to as patch information) generated through patch generation and packing based on vertex coordinates and color information may also be referred to as point cloud data. Therefore, point cloud data including connectivity information may be referred to as mesh data. The terms point cloud and mesh data may be used interchangeably herein.

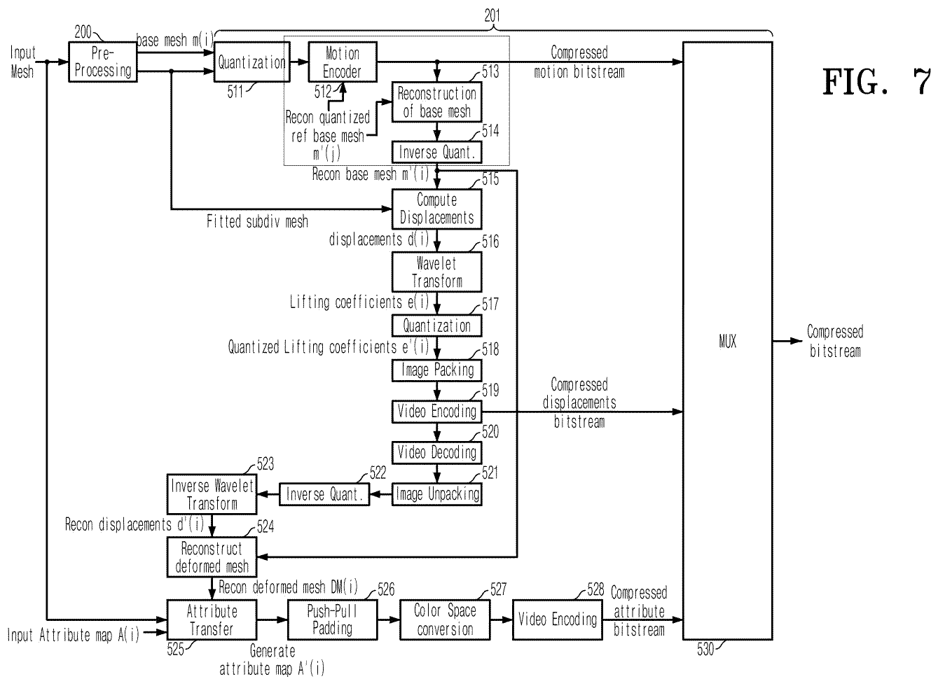

According to embodiments, the V-Mesh compression (reconstruction) method may include intra frame encoding (FIG. 6) and inter frame encoding (FIG. 7).

Based on the results of the GoF generation described above, intra frame encoding or inter frame encoding is performed. In the intra encoding, the data to be compressed may be a base mesh, displacements, an attribute map, and the like. In the inter encoding, the data to be compressed may be displacements, an attribute map, and a motion field between the reference base mesh and the current base mesh.

FIG. 6 illustrates an intra-frame encoding process in a V-MESH compression method according to embodiments. Each component for the intra-frame encoding process of FIG. 6 corresponds to hardware, software, a processor, and/or a combination thereof.

The encoding process of FIG. 6 details the encoding of the mesh video encoder 102 of FIG. 1. That is, it represents the configuration of the mesh video encoder 102 when the encoding of FIG. 1 is intra-frame encoding. The encoder of FIG. 6 may include a pre-processor 200 and/or an encoder 201. The pre-processor 200 and encoder 201 of FIG. 6 may correspond to the pre-processor 200 and encoder 201 of FIG. 3.

The pre-processor 200 may receive an input mesh and perform the pre-processing described above. A base mesh and/or a fitted subdivided mesh may be generated through the pre-processing.

The quantizer 411 of the encoder 201 may quantize the base mesh and/or the fitted subdivided mesh. The static mesh encoder 412 may encode the static mesh (i.e., the quantized base mesh) and generate a bitstream containing the encoded base mesh (i.e., a compressed base mesh bitstream). The static mesh decoder 413 may decode the encoded static mesh (i.e., the encoded base mesh). The inverse quantizer 414 may inversely quantize the quantized static mesh (i.e., base mesh) and output a reconstructed (restored) base mesh. The displacement calculator 415 may generate a displacement or displacements based on the reconstructed static mesh (i.e., base mesh) and the fitted subdivided mesh. According to embodiments, the displacement calculator 415 subdivides the reconstructed base mesh and then calculates a displacement, which is the difference in position of each vertex between the subdivided base mesh and the fitted subdivided mesh. In other words, the displacement is a displacement vector that is the difference in position between the vertices in the two meshes when the fitted subdivided mesh is similar to the original mesh. The forward linear lifter 416 may perform a lifting transform on the input displacements to generate lifting coefficients (also referred to as a transform coefficient). The quantizer 417 may quantize the lifting coefficients. The image packer 418 may pack the image based on the quantized lifting coefficients. The video encoder 419 may encode the packed image. That is, the quantized lifting coefficients are packed into a frame as a 2D image by the image packer 418, compressed by the video encoder 419, and output as a displacement bitstream (i.e., a compressed displacement bitstream).

The video decoder 420 decodes the compressed displacement bitstream. The image unpacker 421 may perform unpacking on the decoded displacement frame to output quantized lifting coefficients. The inverse quantizer 422 may inversely quantize the quantized lifting coefficients. The inverse linear lifting unit 423 applies inverse lifting to the inversely quantized lifting coefficients to generate reconstructed displacements. The mesh reconstructor 424 restores the reconstructed and deformed mesh based on the reconstructed displacements output from the inverse linear lifting unit 423 and the reconstructed base mesh (also referred to as the subdivided reconstructed base mesh) output from the inverse quantizer 414. The reconstructed and deformed mesh is referred to herein as the reconstructed deformed mesh.

The attribute transfer 425 receives an input mesh and/or an input attribute map and regenerates an attribute map based on the reconstructed deformed mesh. The attribute map refers to a texture map corresponding to attribute information among the mesh data components. In the present disclosure, the terms attribute map and texture map may be used interchangeably. The push-pull padding unit 426 may pad data to the attribute map based on a push-pull method. The color space converter 427 may convert the space of the color components of the attribute map. For example, the attribute map may be converted from an RGB color space to a YUV color space. The video encoder 428 may encode the attribute map to output a compressed attribute bitstream.

The multiplexer 430 may multiplex the compressed base mesh bitstream, the compressed displacement bitstream, and the compressed attribute bitstream to generate a compressed bitstream.

In FIG. 6, the displacement calculator 415 may be included in the pre-processor 200. Additionally, at least one of the quantizer 411, the static mesh encoder 412, the static mesh decoder 413, or the inverse quantizer 414 may be included in the pre-processor 200.

As described in FIG. 6, the intra frame encoding method includes base mesh encoding (also referred to as static mesh encoding). That is, when intra frame encoding is performed on the current input mesh frame, the base mesh generated during the pre-processing of the pre-processor 200 may be quantized by the quantizer 411 and then encoded by the static mesh encoder 412 using a static mesh compression technique. In the V-Mesh compression method, for example, the Draco technique is applied to encode the base mesh, and the vertex position information, mapping information (texture coordinates), vertex connectivity information, and the like related to the base mesh are subject to compression.

The encoder in FIG. 6 compresses the base mesh, displacements, and attributes in a frame to generate a bitstream, while the encoder in FIG. 7 compresses the motion, displacements, and attributes between the current frame and a reference frame to generate a bitstream.

FIG. 7 illustrates an inter-frame encoding process in a V-MESH compression method according to embodiments. Each component for the inter-frame encoding process of FIG. 7 corresponds to hardware, software, a processor, and/or a combination thereof.

The encoding process of FIG. 7 details the encoding of FIG. 1 in detail. That is, it represents the configuration of the encoder when the encoding of FIG. 1 is inter-frame encoding. The encoder of FIG. 7 may include a pre-processor 200 and/or an encoder 201. The pre-processor 200 and encoder 201 of FIG. 7 may correspond to the pre-processor 200 and encoder 201 of FIG. 3.

For the components of the encoding operation of FIG. 7 that correspond to the encoding operation of FIG. 6, refers to the description of FIG. 6. That is, the operations of the quantizer 511, displacement calculator 515, wavelet transformer 516, quantizer 517, image packer 518, video encoder 519, video decoder 520, image unpacker 521, inverse quantizer 522, and inverse wavelet transformer 523, mesh reconstructor 524, attribute transfer 525, push-pull padding 526, color space converter 527, video encoder 528, and multiplexer 530 in FIG. 7 are the same as or similar to the operations of the quantizer 411, static mesh encoder 412, static mesh decoder 413, and inverse quantizer 414, displacement calculator 415, forward linear lifting unit 416, quantizer 417, image packer 418, video encoder 419, video decoder 420, image unpacker 421, inverse quantizer 422, inverse linear lifting unit 423, and mesh reconstructor 424, attribute transfer 425, push-pull padding 426, color space converter 427, video encoder 428, and multiplexer 430 in FIG. 6 described above, and are therefore not described in detail in relation to FIG. 7 to avoid redundancy.

In FIG. 7, for inter-frame-based encoding, the motion encoder 512 may obtain and encode a motion vector between the reconstructed quantized reference base mesh and the quantized current base mesh, and output a compressed motion bitstream. The motion encoder 512 may be referred to as a motion vector encoder. The base mesh reconstructor 513 may reconstruct a base mesh based on the reconstructed quantized reference base mesh and the encoded motion vectors. The reconstructed base mesh is inversely quantized by the inverse quantizer 514 and output to the displacement calculator 515.

In FIG. 7, the displacement calculator 515 may be included in the pre-processor 200. Additionally, at least one of the quantizer 511, motion encoder 512, base mesh reconstructor 513, or inverse quantizer 514 may be included in the pre-processor 200.

As described with reference to FIG. 7, the inter-frame encoding method may include motion field encoding (also referred to as motion vector encoding). Inter frame encoding may be performed when the reference mesh and the current input mesh have a one-to-one correspondence of vertices, and only the position information about the vertices differs therebetween. When inter frame encoding is performed, the base mesh may not be compressed. Instead, the difference between the vertices of the reference base mesh and the current base mesh, i.e., the motion field (or motion vector) may be computed and encoded. The reference base mesh is the result of quantizing the decoded base mesh data and is determined by the reference frame index determined in the GoF generation. The motion field may be encoded as it is. Alternatively, a predicted motion field may be calculated by averaging the motion fields of the reconstructed vertices among the vertices connected to the current vertex, and a residual motion field, which is the difference between the value of the predicted motion field and the value of the motion field of the current vertex, may be encoded. The value of the residual motion field may be encoded using entropy coding. Except for the motion field encoding in the inter frame encoding, the process of encoding the displacements and attribute map is the same as the structure of the intra frame encoding method except for the base mesh encoding.

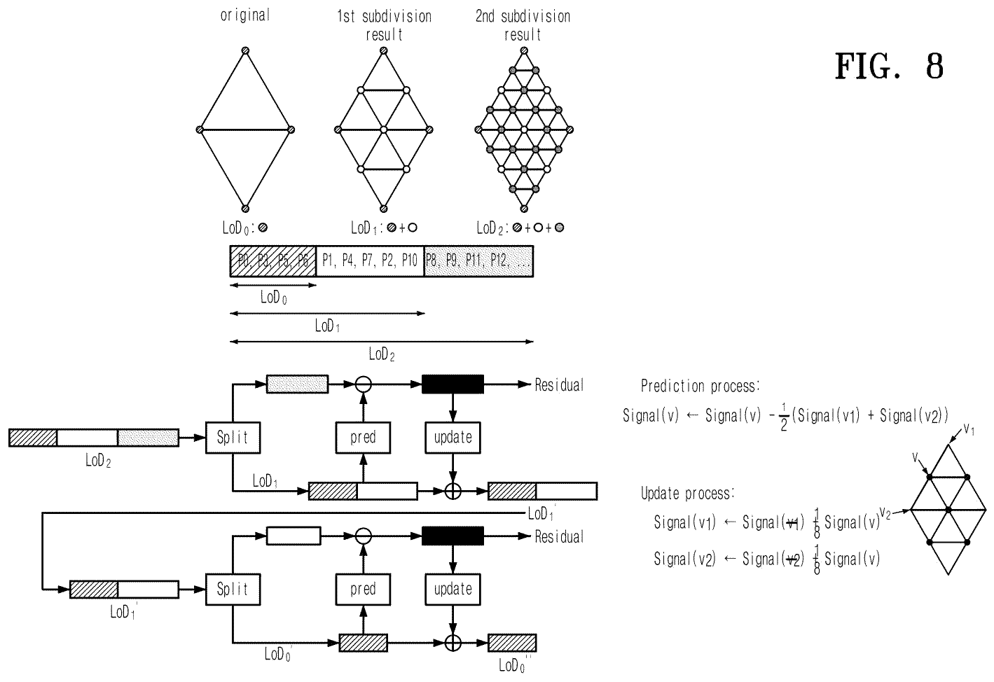

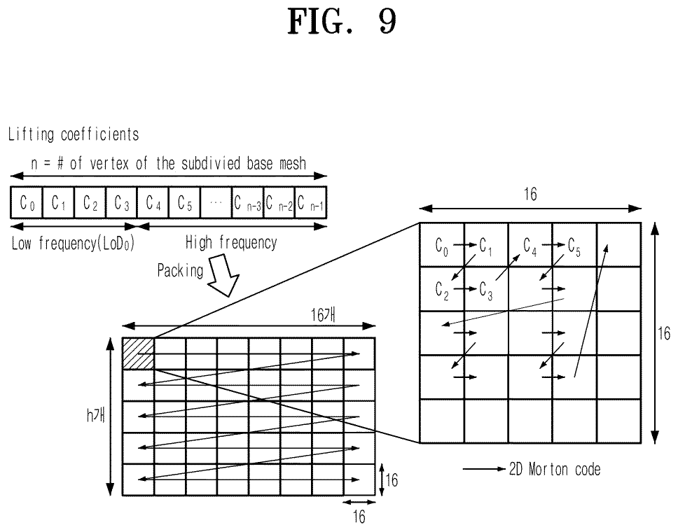

FIG. 8 illustrates a lifting transform process for displacements according to embodiments.

FIG. 9 illustrates a process of packing transform coefficients (also referred to as lifting coefficients) into a 2D image according to embodiments.

FIGS. 8 and 9 illustrate the process of transforming displacements and packing transform coefficients in the encoding process of FIGS. 6 and 7, respectively.

An encoding method according to the embodiments includes displacement encoding.

After base mesh encoding and/or motion field encoding, a reconstructed base mesh may be generated through reconstruction and inverse quantization, and a displacement may be calculated between a result of subdivision of the reconstructed base mesh and a fitted subdivided mesh generated through the fitting subdivision surface (see 415 in FIG. 6 or 515 in FIG. 7). A data transform process, such as a wavelet transform, may be applied to the displacement information for effective encoding (see 416 in FIG. 6, or 516 in FIG. 7).

FIG. 8 illustrates the process of transforming displacement information by the forward linear lifting unit 416 of FIG. 6 or the wavelet transformer 516 of FIG. 7 using the lifting transform. For example, a linear wavelet-based lifting transform may be performed. The transform coefficients generated through the transform process are quantized by the quantizer 417 (or 517) and then packed into a 2D image by the image packer 418 (or 518), as shown in FIG. 9. The transform coefficients may be organized into blocks, one block for every 256 (=16×16) units. Each block may be packed in a z-scan order. The number of rows in a block is fixed to 16, but the number of columns in the block may be determined by the number of vertices in the subdivided base mesh. Within a block, the transform coefficients may be sorted with the Morton code and packed. For the packed images, a displacement video may be generated per GoF. The displacement video may be encoded by the video encoder 419 (or 519) using a conventional video compression codec.

Referring to FIG. 8, the base mesh (original) may include vertices and edges for LoD0. A first subdivision mesh generated by splitting (or subdividing) the base mesh includes vertices generated by further splitting (or subdividing) the edges of the base mesh. The first subdivision mesh contains vertices for LoD0 and vertices for LoD1. LoD1 includes subdivided vertices and vertices from the base mesh (LoD0). The first subdivision mesh may be split (or subdivided) to generate a second subdivision mesh. The second subdivision mesh contains LoD2. LoD2 includes a base mesh vertex (LoD0), LoD1 containing vertices further split (or subdivided) from LoD0, and LoD2 containing vertices further split (or subdivided) from LoD1. LoD is a level of detail that indicates how detailed the mesh data content is. As the index of the level increases, the distance between vertices is shortened, and the level of detail rises. In other words, as the value of LoD decreases, the detail of the mesh data content is degraded. As the value of LoD increases, the detail of the mesh data content is enhanced. LoD N contains the vertices contained in LoD N−1. In the case where the mesh (or vertex) is further split through subdivision, the mesh may be encoded based on a prediction and/or updating method, taking into account the previous vertices v1 and v2, and the subdivided vertex v. Instead of encoding the information for the current LoD N as it is, a residual with respect to previous LoD N−1 may be generated. Thus, the mesh may be encoded using the residual to reduce the size of the bitstream. The prediction process refers to the operation of predicting the current vertex v from the previous vertices v1 and v2. Since neighboring subdivision meshes have similar data, this property may be exploited for efficient encoding. The current vertex position information is predicted from the residual for the previous vertex position information, and the previous vertex position information is updated through the residual. In the present disclosure, vertex and point may be used interchangeably. The LoDs may be defined in the subdivision of the base mesh. According to embodiments, the subdivision of the base mesh may be performed by the pre-processor 200 or may be performed by a separate component/module.

Referring to FIG. 9, a vertex has a transform coefficient (also referred to as a lifting coefficient) generated through lifting transform. The transform coefficient of the vertex related to the lifting transform may be packed into an image by the image packer 418 (or 518) and then encoded by the video encoder 419 (or 519).

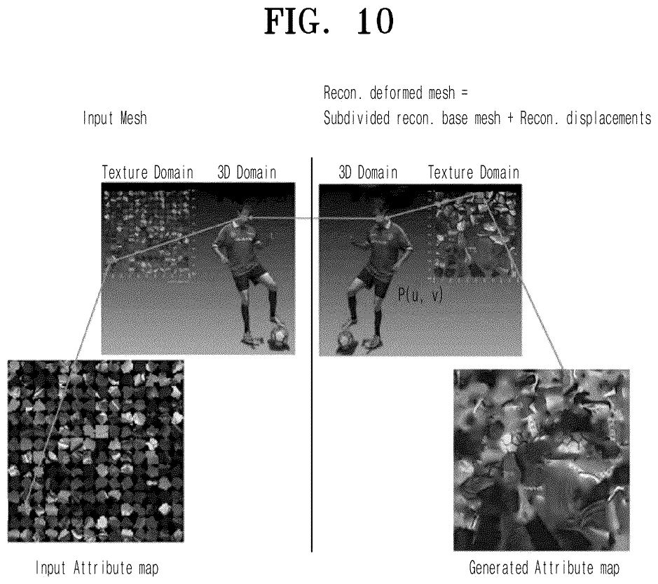

FIG. 10 illustrates an attribute transfer process in a V-MESH compression method according to embodiments.

According to embodiments, FIG. 10 illustrates a detailed operation of the attribute transfer 425 (or 525) in the encoding of FIGS. 6, 7, etc.

The encoding according to the embodiments includes attribute map encoding. According to embodiments, the attribute map encoding may be performed by the video encoder 428 of FIG. 6 or the video encoder 528 of FIG. 7.

According to embodiments, in the present disclosure, the encoder compresses information about the input mesh through base mesh encoding (i.e., intra-encoding), motion field encoding (i.e., inter-encoding), and displacement encoding. The input mesh compressed in the encoding process is reconstructed through base mesh decoding (intra frame), motion field decoding (inter frame), and displacement video decoding, and the reconstructed deformed mesh (hereinafter referred to as Recon. deformed mesh), which is the result of the reconstruction, is used to compress the input attribute map, as shown in FIGS. 6 and 7. The Recon. deformed mesh has position information about vertices, texture coordinates, and corresponding connectivity information, but does not have color information corresponding to the texture coordinates. Therefore, as shown in FIG. 10, in the V-Mesh compression method, a new attribute map having color information corresponding to the texture coordinates of the recon. deformed mesh is re-generated through the attribute transfer process of the attribute transfer 425 (or 525).

According to embodiments, the attribute transfer 425 (or 525) first checks, for every point P (u,v) in the 2D texture domain, whether the corresponding vertex is within a texture triangle of the Recon. deformed mesh. When the corresponding vertex is in the texture triangle T, the attribute transfer calculates the barycentric coordinates (α, β, γ) of P(u, v) according to the triangle T. Then, it calculates the 3D coordinates M(x, y, z) of P(u, v) based on the 3D vertex positions of the triangle T and (α, β, γ). The vertex coordinates M′ (x′, y′, z′) that corresponds to the closest position to the calculated M(x, y, z) and a triangle T′ containing this vertex are searched for in the input mesh domain. Then, the barycentric coordinates (α′, β′, γ′) of M′(x′, y′, z′) in the triangle T′ are calculated. The texture coordinates (u′, v′) are calculated based on the texture coordinates corresponding to the three vertices of triangle T′ and (α′, β′, γ′), and the color information corresponding to the coordinates are searched for in the input attribute map. The color information found in this way is then assigned to the (u, v) pixel position in the new input attribute map. If P(u, v) does not belong to any triangle, the pixel at the position in the new input attribute map be filled with a color value using a padding algorithm, such as the push-pull algorithm of the push-pull padding 426 (or 526).

The new attribute map generated by the attribute transfer 425 (or 525) is bundled into GoFs to construct an attribute map video, which is compressed using a video codec of the video encoder 428 (or 528).

A reference relationship between the input mesh, the input attribute map, the reconstructed deformed mesh, and the reconstructed attribute map is shown may be seen from FIG. 10.

The decoding process of FIG. 1 may perform the reverse of the encoding process of FIG. 1. Specifically, the decoding process is performed as disclosed below.

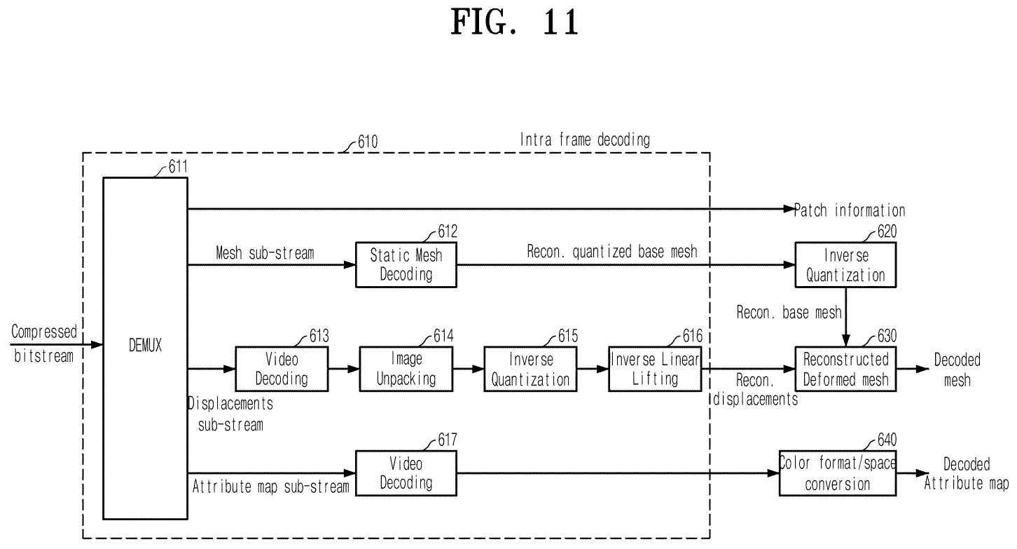

FIG. 11 shows the intra-frame decoding (or intra decoding) process of the V-Mesh technology according to embodiments.

FIG. 11 illustrates the configuration and operation of the mesh video decoder 113 of the reception apparatus of FIG. 1. Additionally, FIG. 11 illustrates that the mesh data may be reconstructed by performing a reverse process to the intra-frame encoding process of FIG. 6. Each component for the intra-frame decoding process of FIG. 11 corresponds to hardware, software, and/or a combination thereof.

First, the bitstream (i.e., compressed bitstream) received and input to the demultiplexer 611 of the intra-frame decoder 610 may be separated into a mesh sub-stream, a displacement sub-stream, an attribute map sub-stream, and a sub-stream containing patch information about the mesh, such as V-PCC/V3C. The term V-PCC (Video-based Point Cloud Compression) used in the present disclosure may have the same meaning as V3C (Visual Volumetric Video-based Coding). The two terms may be used interchangeably. Accordingly, in the present disclosure, the term V-PCC may be interpreted as V3C.

According to embodiments, the mesh sub-stream may be input to and decoded by a static mesh decoder 612, the displacement sub-stream may be input to and decoded by the video decoder 613, and the attribute map sub-stream may be input to and decoded by the video decoder 617.

According to embodiments, the mesh sub-stream may be decoded through the decoder 612 of a static mesh codec used in the encoding such as, for example, Google Draco, to reconstruct connectivity information, vertex geometry information, vertex texture coordinates, and the like related to the result of the decoding, a recon. quantized base mesh, e.g., reconstructed base mesh.

According to embodiments, the displacement sub-stream may be decoded into a displacement video through the decoder 613 of the video compression codec used in the encoding. Then, image unpacking is performed by the image unpacker 614, inverse quantization is performed by the inverse quantizer 615, and inverse transform is performed by the inverse linear lifting unit 616 to reconstruct the displacement information about each vertex (i.e., Recon. displacements).

According to embodiments, the base mesh reconstructed by the static mesh decoder 612 is inversely quantized by the inverse quantizer 620 and output to the mesh reconstructor 630. The mesh reconstructor 630 reconstructs a reconstructed deformed mesh (i.e., a decoded mesh) based on the reconstructed displacements output from the inverse linear lifting unit 616 and the reconstructed base mesh output from the inverse quantizer 620. In other words, the inversely quantized reconstructed base mesh is combined with the reconstructed displacement information to generate a final decoded mesh. In the present disclosure, the final decoded mesh is referred to as a reconstructed deformed mesh.

According to embodiments, the attribute map sub-stream is decoded by the decoder 617 corresponding to the video compression codec used in the encoding, and then a final attribute map (i.e., a decoded attribute map) is reconstructed by the color transformer 640 through color format transform, color space conversion, and the like.

According to embodiments, the reconstructed decoded mesh and decoded attribute map may be utilized at the receiving side as final mesh data that may be utilized by a user.

Referring to FIG. 11, the received compressed bitstream includes patch information, a mesh sub-stream, a displacement sub-stream, and an attribute map sub-stream. The term sub-stream is interpreted as referring to a partial bitstream included in the bitstream. The bitstream contains patch information (data), mesh information (data), displacement information (data), and attribute map information (data).

As described above, the decoder of FIG. 11 performs intra-frame decoding as follows. The static mesh decoder 612 decodes the mesh sub-stream to generate a reconstructed quantized base mesh, and the inverse quantizer 620 applies the quantization parameters of the quantizer in reverse to generate a reconstructed base mesh. The video decoder 613 decodes the displacement sub-stream, the image unpacker 614 unpacks the image of the decoded displacement video, and the inverse quantizer 615 inversely quantizes the quantized image. The inverse linear lifting unit 616 applies a lifting transform in the reverse process of the encoder to generate a reconstructed displacement. The mesh reconstructor 630 generates a reconstructed deformed mesh based on the reconstructed base mesh and the reconstructed displacement. The video decoder 617 decodes the attribute map sub-stream, and the color transformer 640 transforms the color format and/or space of the decoded attribute map to generate a decoded attribute map.

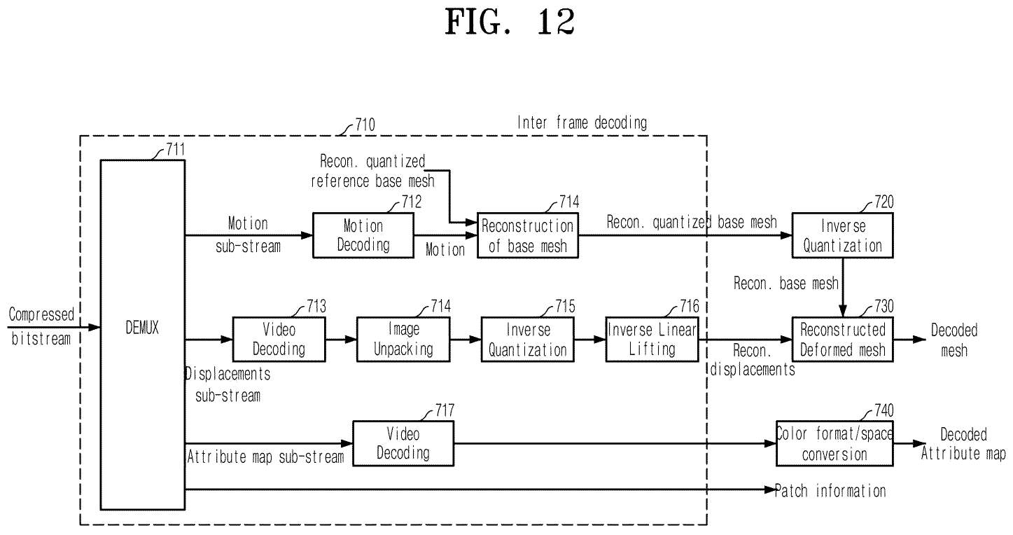

FIG. 12 illustrates an inter-frame decoding (or inter-decoding) process of V-Mesh technology.

FIG. 12 illustrates the configuration and operation of the mesh video decoder 113 of the reception apparatus of FIG. 1. In FIG. 12, mesh data may be reconstructed by performing a reverse process to the inter-frame encoding process of FIG. 7. Each component for the intra-frame decoding process of FIG. 12 corresponds to hardware, software, and/or a combination thereof.

First, the bitstream received and input to the demultiplexer 711 of the intra-frame decoder 710 may be separated into a motion sub-stream (also referred to as a motion vector sub-stream), a displacement sub-stream, an attribute map sub-stream, and a sub-stream containing patch information about the mesh, such as V3C/V-PCC.

According to embodiments, the motion sub-stream may be input to and decoded by the motion decoder 712, the displacement sub-stream may be input to and decoded by the video decoder 713, and the attribute map sub-stream may be input to and decoded by the video decoder 717.

According to embodiments, the motion sub-stream is decoded by the motion decoder 712 through entropy decoding and inverse prediction to reconstruct motion information (also referred to as motion vector information). The base mesh reconstructor 718 combines the reconstructed motion information with a pre-reconstructed and stored reference base mesh to generate a reconstructed quantized base mesh for the current frame. The inverse quantizer 720 applies inverse quantization to the reconstructed quantized base mesh to generate a reconstructed base mesh. The video decoder 713 decodes the displacement sub-stream, the image unpacker 714 unpacks the image of the decoded displacement video, and the inverse quantizer 715 inversely quantizes the quantized image. The inverse linear lifting unit 716 applies a lifting transform in the reverse process of the encoder to generate a reconstructed displacement. The mesh reconstructor 730 generates a reconstructed deformed mesh, i.e., a final decoded mesh, based on the reconstructed base mesh and the reconstructed displacement.

According to embodiments, the video decoder 717 decodes the attribute map sub-stream in the same way as the intra-decoding, and the color transformer 740 transforms the color format and/or space of the decoded attribute map to generate a decoded attribute map. The decoded mesh and decoded attribute map may be utilized at the receiving side as the final mesh data that may be utilized by the user.

Referring to FIG. 12, the bitstream contains motion information (also referred to as motion vectors), displacements, and an attribute map. The process of FIG. 12 further includes decoding the inter-frame motion information because inter-frame decoding is performed. A reconstructed base mesh is generated by decoding the motion information and generating a reconstructed quantized base mesh for the motion information based on the reference base mesh. For the operations in FIG. 12 that are the same as those in FIG. 11, refer to the description of FIG. 11.

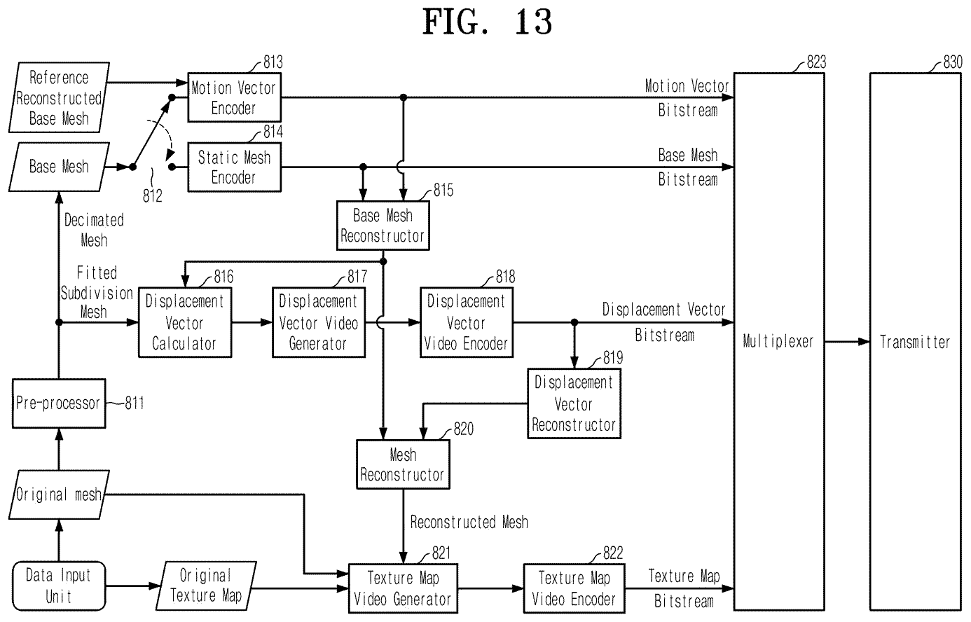

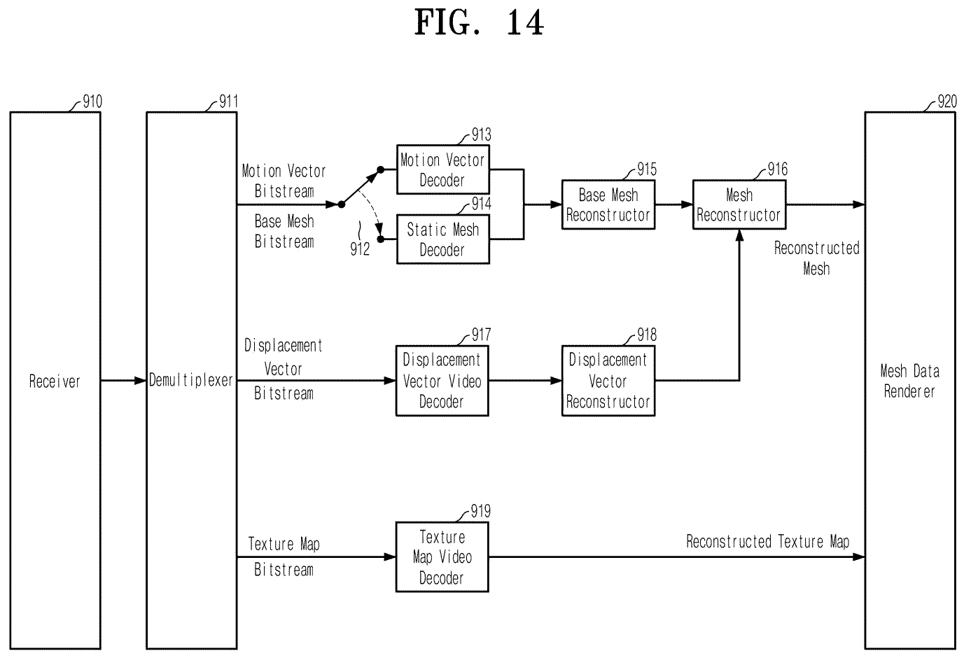

FIG. 13 illustrates a mesh data transmission apparatus according to embodiments.

FIG. 13 corresponds to the transmission apparatus 100 or mesh video encoder 102 of FIG. 1, the encoder (pre-processor and encoder) of FIG. 2, 6, or 7, and/or the corresponding transmission encoding device. Each component of FIG. 13 corresponds to hardware, software, a processor, and/or a combination thereof.

The process of operations at the transmitting end for compressing and transmitting dynamic mesh data using a V-Mesh compression technique may be configured as shown in FIG. 13. The transmission apparatus of FIG. 13 may perform intra-frame encoding (also referred to as intra-encoding or intra-picture encoding) and/or inter-frame encoding (also referred to as inter-encoding or inter-picture encoding).

The pre-processor 811 receives the original mesh and generates a decimated mesh (or base mesh) and a fitted subdivided (or subdivision) mesh. The decimation may be performed based on a target number of vertices or a target number of polygons constituting the mesh. Parameterization may be performed on the decimated mesh to generate texture coordinates and texture connectivity information per vertex. For example, the parameterization is a process of mapping a 3D curved surface into a texture domain for the decimated mesh. When the parameterization is performed using the UVAtlas tool, mapping information indicating where each vertex of the decimated mesh may be mapped to on the 2D image is generated. The mapping information is expressed and stored as texture coordinates, and the final base mesh is generated through this process. The mesh information may be quantized from a floating-point form to a fixed-point form. The result is the base mesh, which may be output to a motion vector encoder 813 or a static mesh encoder 814 through a switching unit 812. The pre-processor 811 may perform a mesh subdivision on the base mesh to generate additional vertices. Depending on the subdivision method, vertex connectivity information including the additional vertices, texture coordinates, and connectivity information about the texture coordinates may be generated. The pre-processor 811 may generate a fitted subdivided mesh by adjusting vertex positions such that the subdivided mesh becomes similar to the original mesh.

According to embodiments, when inter-frame encoding (inter-encoding) is performed on the mesh frame, the base mesh is output to the motion vector encoder 813 through the switching unit 812. When intra-frame encoding (intra-encoding) is performed on the mesh frame, the base mesh is output to the static mesh encoder 814 through the switching unit 812. The motion vector encoder 813 may be referred to as a motion encoder.

For example, when intra-encoding (intra-frame encoding) is performed on the mesh frame, the base mesh may be compressed through the static mesh encoder 814. In this case, the connectivity information, vertex geometry information, vertex texture information, normal information, and the like related to the base mesh may be encoded. The base mesh bitstream generated through the encoding is transmitted to the multiplexer 823.

As another example, when inter-encoding (inter-frame encoding) is performed on the mesh frame, the motion vector encoder 813 may receive as input a base mesh and a reference reconstructed base mesh (or a reconstructed quantized reference base mesh), compute a motion vector between the two meshes, and encode the value thereof. Further, the motion vector encoder 813 may perform connectivity information-based prediction using the previously encoded/decoded motion vector as a predictor, and encode a residual motion vector, which is obtained by subtracting the predicted motion vector from the current motion vector. The motion vector bitstream generated by the encoding is transmitted to the multiplexer 823.

The base mesh reconstructor 815 may receive the base mesh encoded by the static mesh encoder 814 or the motion vector encoded by the motion vector encoder 813, and generate a reconstructed base mesh. For example, the base mesh reconstructor 815 may perform static mesh decoding on the base mesh encoded by the static mesh encoder 814 to reconstruct the base mesh. In this case, quantization may be applied before the static mesh decoding, and inverse quantization may be applied after the static mesh decoding. In another example, the base mesh reconstructor 815 may reconstruct the base mesh based on the reconstructed quantized reference base mesh and the motion vector encoded by the motion vector encoder 813. The reconstructed base mesh is output to the displacement calculator (or displacement vector calculator) 816 and the mesh reconstructor 820.

The displacement calculator 816 may perform mesh subdivision on the reconstructed base mesh. The displacement calculator 816 may calculate a displacement vector, which is the value of the difference in vertex positions between the subdivided reconstructed base mesh and the fitted subdivision (or subdivided) mesh generated by the pre-processor 811. In this case, displacement vectors as many as vertices in the subdivided mesh may be calculated. The displacement calculator 816 may transform the displacement vectors calculated in the 3D Cartesian coordinate system to a local coordinate system based on the normal vector of each vertex.

The displacement vector video generator 817 may include a linear lifting part, a quantizer, and an image packer. That is, in displacement vector video generator 817, the linear lifting unit may transform the displacement vectors for effective encoding. According to embodiments, the transform may be lifting transform, wavelet transform, or the like. In addition, the quantizer may perform quantization on the transformed displacement vector values, i.e., the transform coefficients. In this case, different quantization parameters may be applied to the axes of the transform coefficients, respectively. The quantization parameters may be derived by an agreement between the encoder/decoder. After transform and quantization, the displacement vector information may be packed into a 2D image by the image packer. The displacement vector video generator 817 may generate a displacement vector video by grouping the packed 2D images for each frame. A displacement vector video may be generated for each group of frames (GoF) of the input mesh.

The displacement vector video encoder 818 may encode the generated displacement vector video using a video compression codec. The generated displacement vector video bitstream is transmitted to the multiplexer 823.

The displacement vector reconstructor 819 may include a video decoder, an image unpacker, an inverse quantizer, and an inverse linear lifting part. That is, in the displacement vector reconstructor 819, the encoded displacement vector is decoded by the video decoder, image unpacking is performed by the image unpacker, inverse quantization is performed by the inverse quantizer, and inverse transform is performed by the inverse linear lifting unit to reconstruct displacement vectors. The reconstructed displacement vectors are output to the mesh reconstructor 820. The mesh reconstructor 820 reconstructs a deformed mesh based on the base mesh reconstructed by the base mesh reconstructor 815 and the displacement vectors reconstructed by the displacement vector reconstructor 819. The reconstructed mesh (also referred to as the reconstructed deformed mesh) has reconstructed vertices, inter-vertex connectivity information, texture coordinates, and inter-texture coordinate connectivity information.

The texture map video generator 821 may re-generate a texture map based on the texture map (or attribute map) of the original mesh and the reconstructed deformed mesh output from the mesh reconstructor 820. According to embodiments, the texture map video generator 821 may assign the vertex-by-vertex color information in the texture map of the original mesh to the texture coordinates of the reconstructed deformed mesh. According to embodiments, the texture map video generator 821 may generate a texture map video by grouping the frame-level re-generated texture maps into GoFs.

The generated texture map video may be encoded by the texture map video encoder 822 using a video compression codec. A texture map video bitstream generated through the encoding is transmitted to the multiplexer 823.

The multiplexer 823 multiplexes the motion vector bitstream (in the case of, for example, inter-encoding), the base mesh bitstream (in the case of, for example, intra-encoding), the displacement vector bitstream, and the texture map bitstream into a single bitstream. The single bitstream may be transmitted to the receiving side through the transmitter 824. Alternatively, for the motion vector bitstream, the base mesh bitstream, the displacement vector bitstream, and the texture map bitstream, a file with one or more track data may be generated or the bitstreams may be encapsulated into segments and transmitted to the receiving side through the transmitter 824.

Referring to FIG. 13, the transmitter (encoder) may encode the mesh in an intra-frame or inter-frame manner. According to intra-encoding, the transmission apparatus may generate a base mesh, displacement vectors (or displacements), and a texture map (or attribute map). According to inter-encoding, the transmission apparatus may generate a motion vector (or motion), displacement vectors (or displacements), and a texture map (or attribute map). The texture map acquired from the data input unit is generated and encoded based on the reconstructed mesh. The displacements are generated and encoded based on the differences in vertex positions between the base mesh and the segmented (or subdivided) mesh. More specifically, the displacement is a difference in position between the fitted subdivided mesh and the subdivided reconstructed base mesh, i.e., the difference in vertex position between the two meshes. The base mesh is generated by decimating the original mesh through pre-processing and encoding the decimated mesh. For the motion, a motion vector is generated for the mesh in the current frame based on the reference base mesh in the previous frame.

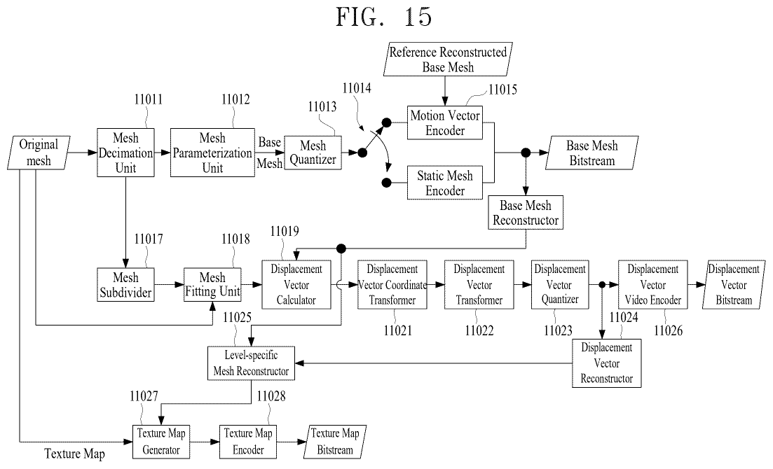

FIG. 14 illustrates a mesh data reception apparatus according to embodiments.

FIG. 14 corresponds to the reception apparatus 110 or mesh video decoder 113 of FIG. 1, the decoder of FIG. 11 or 12, and/or a corresponding receiving decoding device. Each component of FIG. 14 corresponds to hardware, software, a processor, and/or a combination thereof. The reception (decoding) operation of FIG. 14 may follow a reverse process to the corresponding process of the transmission (encoding) operation of FIG. 13.

The bitstream of mesh data received by the receiver 910 is subjected to file/segment decapsulation and then demultiplexed by the demultiplexer 911 into a compressed motion vector bitstream (e.g., inter-decoding) or base mesh bitstream (e.g., intra-decoding), a displacement vector bitstream, and a texture map bitstream. For example, when the current mesh is inter-frame encoded (i.e., inter-encoded), the motion vector bitstream is received, demultiplexed, and then output to the motion vector decoder 913 through the switching unit 912. In another example, when the current mesh is intra-frame encoded (i.e., intra-encoded), the base mesh bitstream is received, demultiplexed, and output to the static mesh decoder 914 through the switching unit 912. Here, the motion vector decoder 913 may be referred to as a motion decoder.

According to embodiments, in the case where inter-frame encoding is applied to the current mesh based on the frame header information, the motion vector decoder 913 may decode the motion vector bitstream. According to embodiments, the motion vector decoder 913 may use the previously decoded motion vector as a predictor and add the same to the residual motion vector decoded from the bitstream to reconstruct the final motion vector.

According to embodiments, in the case where intra-frame encoding is applied to the current mesh based on the frame header information, the static mesh decoder 914 may decode the base mesh bitstream to reconstruct connectivity information, vertex geometry information, texture coordinates, normal information, and the like related to the base mesh.

According to embodiments, the base mesh reconstructor 915 may reconstruct the current base mesh based on the decoded motion vectors or the decoded base mesh. For example, in the case where inter-frame encoding is applied to the current mesh, the base mesh reconstructor 915 may add the decoded motion vectors to the reference base mesh and perform inverse quantization to generate a reconstructed base mesh. In another example, in the case where intra-frame encoding is applied to the current mesh, the base mesh reconstructor 915 may perform inverse quantization on the base mesh decoded by the static mesh decoder 914 to generate a reconstructed base mesh.

According to embodiments, the displacement vector video decoder 917 may decode the displacement vector bitstream as a video bitstream using a video codec.

According to embodiments, the displacement vector reconstructor 918 extracts displacement vector transform coefficients from the decoded displacement vector video, and applies inverse quantization and inverse transform to the extracted displacement vector transform coefficients to reconstruct displacement vectors. To this end, the displacement vector reconstructor 918 may include an image unpacker, an inverse quantizer, and an inverse linear lifting part. If the reconstructed displacement vectors are values in a local coordinate system, inverse transform to the Cartesian coordinate system may be performed.

The mesh reconstructor 916 may subdivide the reconstructed base mesh to generate additional vertices. Through the subdivision, vertex connectivity information including the additional vertices, texture coordinates, and connectivity information about the texture coordinates may be generated. In this case, the mesh reconstructor 916 may combine the subdivided reconstructed base mesh with the reconstructed displacement vectors to generate a final reconstructed mesh (also referred to as a reconstructed deformed mesh).

According to embodiments, the texture map video decoder 919 may decode the texture map bitstream as a video bitstream using a video codec to reconstruct a texture map. The reconstructed texture map has color information about each vertex in the reconstructed mesh, and the texture coordinates of each vertex may be used to obtain the color value of the vertex from the texture map.

According to embodiments, the mesh reconstructed from the mesh reconstructor 916 and the texture map reconstructed from the texture map video decoder 919 are presented to the user through a rendering process in the mesh data renderer 920.

Referring to FIG. 14, the reception apparatus (decoder) may decode the mesh in an intra-frame or inter-frame manner. According to intra-decoding, the reception apparatus may receive a base mesh, displacement vectors (or displacements), and a texture map (or attribute map), and render mesh data based on the reconstructed mesh and reconstructed texture map. According to inter-decoding, the reception apparatus may receive a motion vector (or motion), the displacement vectors (or displacements), a texture map (or attribute map), and render mesh data based on the reconstructed mesh and the reconstructed texture map.

A mesh data transmission device and method according to embodiments may pre-process mesh data, encode the pre-processed mesh data, and transmit a bitstream containing the encoded mesh data. A point mesh data reception device and method according to embodiments may receive a bitstream containing mesh data and decode the mesh data. The mesh data transmission/reception method/device according to embodiments may be referred to as a method/device according to embodiments. The mesh data transmission/reception method/device may also be referred to as a 3D data transmission/reception method/device or point cloud data transmission/reception method/device.

As described above, in the V-Mesh method, the displacement information generated during the encoding process is converted into a video, which is compressed using an existing 2D video codec. In addition, the texture map (equivalent to an attribute map) of the input mesh data is also processed into a video, which is compressed using an existing 2D video codec. In this case, the displacement video and texture map video are generated and encoded based on the user-defined resolution, and are reconstructed at the same resolution on the receiving side. However, in the case where some video bitstream data is lost due to poor network conditions on the receiving side, the entire video data may not be fully reconstructed with the current V-Mesh method. Furthermore, if the available resource level on the receiving side is not sufficient to reconstruct and utilize the transmitted mesh data, the received mesh data may not be used at all.

To address these issues, the present disclosure proposes a device and method for transmitting a bitstream with scalable encoding of mesh data to allow the data to be received at a manageable level and reconstruct the data to the maximum possible level on the receiving side. In particular, to enable the V-Mesh method to perform scalable encoding/decoding, the present disclosure proposes a scalable encoding/decoding device and method for displacement video and texture map video.

Currently, the displacement information generated with the V-Mesh method is processed and encoded as a video, but compression by a video codec may be inefficient because the displacement information actually added to the video data has little temporal/spatial redundancy. Therefore, the compression performance of V-Mesh may be further improved by applying a more efficient encoding method that reflects the characteristics of the displacement information. To this end, the present disclosure proposes a method of encoding displacement information in a manner other than the video compression method, and proposes a scalable encoding/decoding device and method based thereon.

In particular, the present disclosure proposes a scalable mesh encoding/decoding device and method that is scalable by including one or more sub-bitstream sets with various resolutions and image quality. To this end, the present disclosure proposes a device and method that may reflect scalability for displacement video and texture map video that are compressed using a conventional 2D video codec in the V-Mesh method. The present disclosure also proposes a device and method that may provide not only scalability but also additional improvement of compression efficiency for displacement video.

Thus, according to the present disclosure, hierarchical encoding/decoding of the mesh data may be enabled and mesh content with optimal resolution and image quality may be selectively reconstructed and provided based on the network and reception environments.

As described above, the disclosure relates to a method of hierarchically partitioning and compressing displacement information and texture map information by a V-Mesh encoder of a transmission device, and to a device and method for hierarchically encoding displacement information by applying an encoding method that is not in the 2D video form. The present disclosure also relates to a method of decoding displacement information and texture map information up to a target layer by a V-Mesh decoder of a reception device, and to a device and method for decoding mesh data up to the target layer using the same.

In the present disclosure, displacement video may be used interchangeably with displacement vector video or displacement vector transform coefficient video. Also, displacement may be used interchangeably with displacement information or displacement vector.

Regarding the transmission device of the present disclosure, proposed herein are a scalable encoding method of V-Mesh, a scalable encoding method for a displacement video of V-Mesh, and a method of improving compression performance of V-Mesh displacement information. Further, regarding the transmission device, proposed herein are a scalable encoding method for a new displacement information encoding method and a scalable encoding method for a texture map video of V-Mesh.

Regarding the reception device of the present disclosure, proposed herein are a scalable decoding method of V-Mesh, a scalable decoding method for a displacement video of V-Mesh, and a method of improving compression performance of V-Mesh displacement information. Further, regarding the reception device, proposed herein are a scalable encoding method for a new displacement information encoding method and a scalable encoding method for a texture map video of V-Mesh.

In the present disclosure, geometry information (or geometry or geometry data), which is one of the elements that constitute a mesh, includes vertices (or points), edges, and polygons. Here, a vertex defines a position in 3D space, an edge represents connectivity between vertices, and a polygon, formed by a combination of edges and vertices, defines the surface of the mesh. In other words, each vertex that constitutes the mesh represents a position in 3D space, expressed by, for example, X, γ, and Z coordinates. The polygon may be a triangle or a rectangle. In other words, geometry forms the skeleton of a 3D model, defining the shape of a model, which is visually represented when rendered.

FIG. 15 illustrates a mesh data transmission device according to embodiments. The transmission device of FIG. 15 may be referred to as a scalable V-Mesh encoder.

FIG. 15 corresponds to the transmission device 100 or mesh video encoder 102 of FIG. 1, the encoder (preprocessor and encoder) of FIG. 2, 6, or 7, the transmission device of FIG. 13, and/or the corresponding transmission encoding device. Each component of FIG. 15 corresponds to hardware, software, a processor, and/or a combination thereof. In FIG. 15, the execution order of the blocks may be changed, some blocks may be omitted, and new blocks may be added.

In the transmission device of FIG. 15, the V-Mesh encoder may encode the mesh using a progressive encoding method that simplifies the original mesh to create a base mesh, and then gradually builds a complex mesh from the base mesh.

That is, the operation process on the transmitting side for compression and transmission of dynamic mesh data using the V-Mesh compression technique may be performed as illustrated in FIG. 15. The transmission device of FIG. 15 may support both an intra-frame encoding (or intra encoding or intra-screen encoding) process and/or an inter-frame encoding (or inter encoding or inter-screen encoding) process.

In FIG. 15, the mesh decimation unit (or part) 11011 simplifies the input original mesh to generate a decimated base mesh. The mesh simplification may be performed based on the number of target vertices or the number of target polygons constituting the mesh. For example, methods such as decimation may be used to simplify the original mesh. Specifically, the decimation may be a process of selecting vertices to be removed from the original mesh based on a certain reference point, and then removing the selected vertices and the triangles connected to the selected vertices.

In other words, the mesh decimation unit 11011 may decimate the input mesh to a target number of vertices or a target number of faces. The decimation process may be performed using various methods, such as triangle collapse and edge collapse.

According to embodiments, the base mesh decimated by the mesh decimation unit 11011 is provided to the mesh parameterization unit 11012 and the mesh subdivider 11017.

The mesh parameterization unit 11012 performs a process of mapping 3D surfaces to a texture domain for the decimated mesh. In one embodiment, the mesh parameterization unit 11012 may perform the parameterization using a UVAtlas tool. In this process, mapping information indicating where each vertex of the decimated mesh may be mapped to on the 2D image is generated. The mapping information is expressed and stored as texture coordinates, and the final base mesh is generated in this process. In other words, the mesh parameterization unit 11012 performs parameterization to generate texture coordinates (UV coordinates) and texture connectivity information per vertex of the input mesh (i.e., the decimated mesh).

The final base mesh generated by the parameterization unit 11012 is input to the mesh quantizer 11013 to be quantized. According to embodiments, the mesh quantizer 11013 may quantize the mesh information (e.g., geometry information (x,y,z) and/or texture coordinates (u,v), normal information (nx, ny, nz), etc.) in floating point form to fixed point form. In some embodiments, quantization of a specific component may be skipped.

The mesh subdivider 11017 subdivides the base mesh obtained through decimation by the mesh decimation unit 11011. The mesh subdivider 11017 may perform a mesh subdivision on the base mesh to generate additional vertices. Depending on the subdivision method, vertex connectivity information, texture coordinates, and connectivity information about the texture coordinates including the additional vertices may be generated. In this case, the geometry information connectivity information, texture coordinate connectivity information, and texture coordinates are may be implicitly inferred and generated according to the subdivision method. According to embodiments, the mesh subdivider 11017 may perform the subdivision using a method such as mid-edge, Loop, or Catmul&Clark.

Further, the mesh subdivision by the mesh subdivider 11017 may be performed n times by a user parameter or by an agreement between the encoder (i.e., transmission device)/decoder (i.e., reception device). According to embodiments, when defining the vertices of the base mesh as R₀, the vertices newly generated by performing the subdivision once as R1, . . . , and the vertices generated by performing the subdivision n times as Rn, the level of detail (LoDn) may be defined as shown in Equation 1 below.

$${LoD}_{n} = {R}_{0} ⋃ {R}_{1} ⋃ , … , ⋃ {R}_{n} \qquad [ Equation 1 ]$$

Referring to FIG. 8 for mesh subdivision, the base mesh (original) may include vertices and edges for LoD0. A first subdivision mesh generated by dividing (or subdividing) the base mesh includes vertices generated by further dividing (or subdividing) the edges of the base mesh. The first subdivision mesh includes vertices for LoD0 and vertices for LoD1. LoD1 contains subdivided vertices and the vertices from the base mesh (LoD0). A second subdivision mesh may be generated by dividing (or subdividing) the first subdivision mesh. The second subdivision mesh includes LoD2. LoD2 contains the base mesh vertices (LoD0), LoD1 containing vertices further divided (or subdivided) from LoD0, and vertices further divided (or subdivided) from LoD1. In other words, the LoD is a level of detail that represents the degree of detail of the mesh data content. As the index of the level increases, the distance between vertices decreases and the level of detail rises. In other words, a smaller LoD value indicates that the mesh data content is less detailed, while a larger LoD value indicates that the mesh data content is more detailed. LoD N contains the same vertices included in the previous LoD, LoDN−1. In the present disclosure, vertex and point may be used interchangeably. LoDs may be defined during the subdivision of the base mesh.

According to embodiments, the mesh fitting unit 11018 may perform fitting by adjusting the vertex positions such that the subdivided mesh from the mesh subdivider 11017 becomes similar to the original mesh, thereby generating a fitted subdivided mesh.

In the present disclosure, the combination of the mesh decimation unit 11011, the parameterization unit 11012, the mesh subdivider 11017, and the mesh fitting unit 11018 may be referred to as a pre-processor. According to embodiments, the pre-processor may further include a displacement vector calculator 11019.

According to embodiments, the base mesh from the mesh quantizer 11013 may be output to a motion vector encoder 11015 or a static mesh encoder 11016 through a switching unit 11014.

According to embodiments, when inter-frame encoding (inter-encoding) is performed on the mesh frame, the base mesh is output to the motion vector encoder 11015 through the switching unit 11014. When intra-frame encoding (intra-encoding) is performed on the mesh frame, the base mesh is output to the static mesh encoder 11016 through the switching unit 11014. The motion vector encoder 11015 may be referred to as a motion encoder.

For example, when intra-encoding (intra-frame encoding) is performed on the mesh frame, the base mesh may be compressed by the static mesh encoder 11016. In this case, the connectivity information, vertex geometry information, vertex texture information, normal information, and the like related to the base mesh may be encoded. The base mesh bitstream generated through the encoding is transmitted to the multiplexer (not shown).

As another example, when inter-encoding (inter-frame encoding) is performed on the mesh frame, the motion vector encoder 11015 may receive as input a base mesh and a reference reconstructed base mesh (or a reconstructed quantized reference base mesh), calculate a motion vector between the two meshes, and encode the value thereof. Further, the motion vector encoder 11015 may perform connectivity information-based prediction using the previously encoded/decoded motion vector as a predictor, and perform entropy encoding on a difference motion vector (also referred to as a residual motion vector), which is obtained by subtracting the predicted motion vector from the current motion vector. The motion vector bitstream generated through the encoding is transmitted as the base mesh bitstream to the multiplexer (not shown). That is, in the case of intra-frame encoding, the static mesh bitstream is input to the multiplexer as the base mesh bitstream. In the case of inter-frame encoding, the motion vector bitstream is input to the multiplexer as the base mesh bitstream.

According to embodiments, encoding may be performed by the motion vector encoder 11015 on a vertex-by-vertex or subgroup-by-subgroup basis.

In FIG. 15, the base mesh reconstructor 11020 may receive the base mesh encoded by the static mesh encoder 11016 or the motion vectors encoded by the motion vector encoder 11015, and generate a reconstructed base mesh. The base mesh reconstructor 11020 reconstruct the base mesh based on the encoding type of the current mesh (inter-frame encoding or intra-frame encoding). For example, the base mesh reconstructor 11020 may reconstruct the base mesh by performing static mesh decoding on the base mesh encoded by the static mesh encoder 11016. In this case, quantization may be applied before the static mesh decoding, and inverse quantization may be applied after the static mesh decoding. In other words, when intra-frame encoding is performed, inverse quantization may be performed on the base mesh quantized by the mesh quantizer 11013 to reconstruct the current base mesh. As another example, the base mesh reconstructor 11020 may reconstruct the base mesh based on the reconstructed quantized reference base mesh and the motion vectors encoded by the motion vector encoder 11015. In other words, when inter-frame encoding is performed, the reconstructed motion vectors may be added to the reference reconstructed base mesh to generate the current base mesh. In this case, in the case where the motion vectors are not quantized, the motion vector reconstruction process may be skipped, and the motion vectors calculated by the motion vector encoder 11015 may be used to reconstruct the current base mesh. The reconstructed base mesh is output to the displacement vector calculator 11019 and the level-specific mesh reconstructor 11025.

According to embodiments, the displacement vector calculator 11019 may perform mesh subdivision on the reconstructed base mesh. Further, the displacement vector calculator 11019 may calculate a displacement vector, which is the value of the difference in vertex position between the subdivided reconstructed base mesh and the fitted subdivision (or subdivided) mesh generated by the mesh fitting unit 11018. In this case, the displacement vectors may be calculated as many times as the number of vertices in the subdivided mesh. In other words, the displacement vectors corresponding to the number of vertices in the subdivided mesh may be calculated by the displacement vector calculator 11019.

According to embodiments, the displacement vector coordinate transformer 11021 may transform the vertex displacement vectors calculated in a 3D Cartesian coordinate system (i.e., (x, y, z) space) to a local coordinate system (i.e., a normal, tangential, bi-tangential coordinate system) based on the normal vector of each vertex. Here, the normal vector may be calculated for each subdivided vertex based on the geometry information and connectivity information about neighboring vertices.

According to embodiments, the displacement vector transformer 11022 may perform a transformation on the displacement vector in the (x, y, z) or (n, t, bt) coordinate system. According to embodiments, lifting transform, wavelet transform, or the like may be applied for the transformation. In the (n, t, bt) coordinate system, n denotes normal, t denotes tangential, and bt denotes bi-tangential.

For example, when lifting transform is performed to predict vertex Rx of the k-th subdivision level, the subdivided vertex displacement vector of Rt may be used as a predictor for displacement vector prediction at the k-th subdivision level (where t<k or t<=k). In some embodiments, the prediction of the displacement vector may be an average prediction or distance-based weighted average prediction of the nearest n points based on connectivity information among the vertices at a lower subdivision level than the current vertex. In some embodiments, the prediction may be based on the displacement vectors of the n vertices used to generate the current vertex in the mesh subdivision operation.

Then, when lifting transform is performed, the residual signal generated by the prediction may be used to update the displacement vectors of the vertices used in the prediction.

According to embodiments, the displacement vector quantizer 11023 may quantize the displacement vector values transformed by the displacement vector transformer 11022, i.e., the transform coefficients. The transform coefficients may be quantized through a different quantization parameter for each axis, and the quantization parameters or scaling parameters may be derived by an agreement made by the encoder/decoder to determine a quantization rate for each LoD level. According to embodiments, the displacement vector reconstructor 11024 may perform displacement vector reconstruction by de-quantizing the quantized displacement vector.

According to embodiments, the level-specific mesh reconstructor 11025 may reconstruct a deformed mesh based on the displacement vectors reconstructed by the displacement vector reconstructor 11024 and the base mesh reconstructed by the base mesh reconstructor 11020. More specifically, the level-specific mesh reconstructor 11025 may subdivide the reconstructed base mesh generated by the base mesh reconstructor 11020 and add the reconstructed displacement vectors from the displacement vector reconstructor 11024 to generate a LoD (or sLoD) level-specific reconstructed mesh. According to embodiments, the LoD (or sLoD) level-specific reconstructed mesh generated by the level-specific mesh reconstructor 11025 is provided to the texture map generator 11027.

That is, the level-specific mesh reconstructor 11025 may generate a LoD0 reconstructed mesh by adding corresponding displacement vectors to the vertices of the reconstructed base mesh, generate a LoD1 reconstructed mesh by subdividing the reconstructed base mesh once and adding the displacement vectors to the subdivided mesh, and generate a LoD, reconstructed mesh by subdividing the reconstructed base mesh n times and adding the displacement vectors to the subdivided mesh. In this case, the level-specific mesh reconstructor 11025 may generate a reconstructed mesh for each LoD, or may generate a reconstructed mesh for each scalable level of detail (sLoD), which is a user-defined scalable level. The sLOD will be described in more detail below under “First embodiment of a displacement vector encoding method.”

According to embodiments, the displacement vector encoder 11026 may encode displacement vector transform coefficients quantized by the displacement vector quantizer 11023.

In the present disclosure, the displacement vector encoder 11026 may encode the displacement vector transform coefficients by performing one of various methods described below for scalable encoding/decoding.

According to embodiments, the displacement vector encoder 11026 may pack the displacement vector transform coefficients into a 2D image, and may then encode the image using a 2D video codec (e.g., a video compression codec) or perform zero run-length encoding to generate a displacement vector video bitstream.

According to embodiments, the displacement vector video bitstream generated through encoding by the displacement vector encoder 11026 is transmitted to a multiplexer (not shown). According to embodiments, regarding the method of selecting the displacement vector encoder 11026, a displacement vector encoder agreed upon by the encoder (i.e., transmitting side)/decoder (i.e., receiving side) may be used, or the encoder on the transmitting side may transmit the type of displacement vector encoder selected through analysis of the characteristics of the displacement vectors to the decoder on the receiving side.

Next, various encoding methods sued for the displacement vectors by the displacement vector encoder 11026 are described.

### First Embodiment of Displacement Vector Encoding Method

The displacement vector transform coefficients quantized by the displacement vector quantizer 11023 may be packed into a 2D image and encoded by the displacement vector encoder 11026 using a 2D video codec.

In this case, for scalable encoding, 2D videos may be generated for each LoD defined by the mesh subdivider 11017. That is, by grouping transform coefficients corresponding to each LoD and packing the same into each 2D image, 2D videos may be generated for each LoD and encoded using a scalable video codec. In this case, a video codec may be provided for each LoD. As an example, a 2D video may be generated based on the transform coefficients corresponding to LoD2 and encoded using a video codec for LoD2.

Alternatively, in the present disclosure, sLoDs, which are scalable levels, may be defined and displacement vector videos may be generated by packing images for each sLoD. The displacement vector videos may be encoded using a scalable video codec. In other words, by grouping the transform coefficients corresponding to each sLoD and packing the same into each 2D image, 2D videos for each sLoD may be generated and encoded using a scalable video codec. In this case, video codecs may be provided for each sLoD. In the case of sLoD3, for example, a 2D video may be generated based on the transform coefficients corresponding to sLoD3 and encoded using a video codec for sLoD3.

In this case, the sLoDs for scalable support may be defined separately from the LoDs determined by the mesh subdivider 11017, and/or may be configured based on the LoDs. In other words, a specific sLoD level may be mapped to the same LoD level, or may be mapped to a different LoD level. For example, sLoD1 may be mapped to LoD1 or may be mapped to LoD3. This means that the number of sLoD levels may or may not be equal to the number of LoD levels. For example, the number of sLoD levels may be 5, and the number of LoD levels may be 5 or 10. If the number of LoD levels is 10 (e.g., LoD0 to LoD9), and sLoD0, sLoD1, sLoD2, and sLoD3 are mapped to LoD0, LoD2, LoD5, and LoD10, respectively, the number of sLoD levels is 4.

In the present disclosure, sLoDs may be defined by either the mesh subdivider 11017 or the displacement vector encoder 11026. Alternatively, they may be defined by another separate block or software. Further, defining sLoDs for scalability is intended to increase versatility, and LoDs may be grouped and simplified by defining sLoDs for only specific (or major) LoD levels among the LoD levels.

According to embodiments, the number of sLoD levels (e.g., num_scalable_LoD_minus1) and the corresponding LoD level value for each sLoD level may be transmitted, and whether or not an sLoD is transmitted may be determined through a 1-bit flag (e.g., sLoD_enable_flag). For example, sLoD_enable_flag set to 1 may indicate that the displacement vector transform coefficient is encoded on an sLoD basis, and sLoD_enable_flag set to 0 may indicate that the displacement vector transform coefficient is encoded on a LoD basis. In another embodiment, the LoD level values corresponding to the respective sLoD levels may be predetermined by an agreement made on the transmitting side/receiving side. Alternatively, only sLoD level values may be tabulated and transmitted such that the LoD levels mapped to the sLoD levels may be extracted based on the table.

According to embodiments, the number of sLoD levels (e.g., num_scalable_LoD_minus1) and the LoD level values (e.g., LoD_level_idx) corresponding to the sLoD levels may be transmitted in signaling information.

According to embodiments, the number of sLoD levels (e.g., num_scalable_LoD_minus1) and the sLoD level value (e.g., sLoD_idx) may be transmitted in the signaling information.

According to embodiments, the number of sLoD levels (e.g., num_scalable_LoD_minus1), the LoD level values corresponding to the sLoD levels (e.g., LoD_level_idx), and the sLoD level values (e.g., sLoD_idx) may be transmitted in the signaling information.

According to embodiments, when the LoD is composed of N levels in the mesh subdivider 11017, and num_scalable_LoD_minus1)=k−1, the k−1-th LoD_level_idx may be implicitly derived as N−1 by the reception device.

For example, when the LoD has N levels and the sLoD has k levels, the level values of the LoD corresponding to the level values of the sLoD may be defined as shown in Table 1 below. When sLoD is defined as in the case of Table 1, a displacement vector video corresponding to sLoD=1 means that the quantized displacement vector transform coefficients corresponding to LoD=3 are packed into a 2D image to configure a video.

TABLE 1

| sLoD index | Corresponding LoD level index |
|---|---|
| 0 | 0 |
| 1 | 3 |
| . . . | . . . |
| k − 1 | N − 1 |

According to embodiments, the images of transform coefficients organized per LoD or sLoD may be temporally stacked within a group of frames (GoF) to configure a displacement vector video and encoded using a video codec. In the case of sLoD1, for example, the transform coefficients corresponding to sLoD1 are grouped together and packed into a 2D image to generate a 2D frame. It means that a GoF consisting of one I frame, at least one B frame, and at least one P frame is also composed of 2D frames corresponding to sLoD1.

As described above, in the first embodiment of the method of encoding displacement vectors by the displacement vector encoder 11026, a LoD-specific or sLoD-specific 2D video may be generated by grouping the transform coefficients corresponding to each LoD or each sLoD together and packing the same into a respective 2D image, and may be encoded using a scalable video codec. In the case of LoD2, for example, a 2D video may be generated based on the transform coefficients corresponding to LoD2 and then encoded using a video codec for LoD2. In the case of sLoD3, for example, a 2D video may be generated based on the transform coefficients corresponding to sLoD3 and then encoded using a video codec for sLoD3.

### Second Embodiment of Displacement Vector Encoding Method

According to embodiments, the displacement vector transform coefficients quantized by the displacement vector quantizer 11023 may have low spatial/temporal redundancy, which may make compression using a 2D video codec inefficient. That is, as described above, the displacement vector calculator 11019 may perform mesh subdivision on the reconstructed base mesh and then calculate a displacement vector, which is the value of the difference ni vertex position between the subdivided reconstructed base mesh and the fitted subdivision (or subdivided) mesh generated by the mesh fitting unit 11018. Thus, the values of the displacement vector are mostly zero or close to zero. Furthermore, quantizing these displacement vectors increases the number of zeros.

The present disclosure takes advantage of this feature to encode the displacement vectors using another encoder (e.g., a zero run-length encoder) instead of the 2D video codec. Again, zero run-length encoding may be performed for specific LoD levels or only for specific sLoD levels. In the case of LoD2, for example, zero run-length coding may be performed on the (quantized) displacement vector transform coefficients corresponding to LoD2. In the case of sLoD3, for example, zero run-length coding may be performed on the (quantized) displacement vector transform coefficients corresponding to sLoD3. In this case, zero run-length coders corresponding to the number of LoD levels and/or the number of sLoD levels may be required.

In the present disclosure, an arithmetic coder may be used as a zero run-length coder for zero run-length encoding.

In other words, in the present disclosure, the zero run-length encoding may be applied instead of a 2D video codec to encode displacement vector transform coefficients to further improve compression efficiency and enable scalable encoding.

According to embodiments, the displacement vector coordinate transformer 11021 may transform the vertex displacement vectors calculated in a 3D Cartesian coordinate system (i.e., (x, y, z) space) to a local coordinate system (e.g., (n, t, bt) space) based on the normal vector of each vertex.

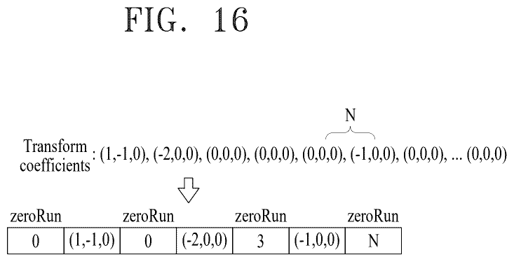

According to embodiments, regarding the displacement vector transform coefficients (disp₀, disp₁, disp₂) (disp₀, disp₁, disp₂) of the (x,y,z) or (n,t,bt) coordinate system, when the displacement vector transform coefficients of the individual axes are all zero (i.e., (0,0,0)), as shown in FIG. 16, the value of zeroRun may be increased and the transform coefficient encoder may be omitted. The axial components corresponding to disp₀, disp₁, and disp₂ in FIG. 16 may vary according to embodiments.

FIG. 16 is a diagram illustrating an example of zero run-length encoding according to embodiments.

In FIG. 16, when the (quantized) displacement vector transform coefficients (disp₀, disp₁, disp₂) are (1,−1,0), (−2,0,0), (0,0,0), (0,0,0), (0,0,0), (0,0,0), (−1,0,0), and N terms of (0,0,0), the value of zeroRun for (1,−1,0) is 0 because (1,−1,0) is not followed by the displacement vector transform coefficient components of the three axes equal to 0, i.e., (0,0,0); the value of zeroRun for (−2,0,0) is 3 because (−2,0,0) is followed by 3 terms of (0,0,0); the value of zeroRun for (−1,0,0) is N because (−1,0,0) is followed by N terms of (0,0,0).

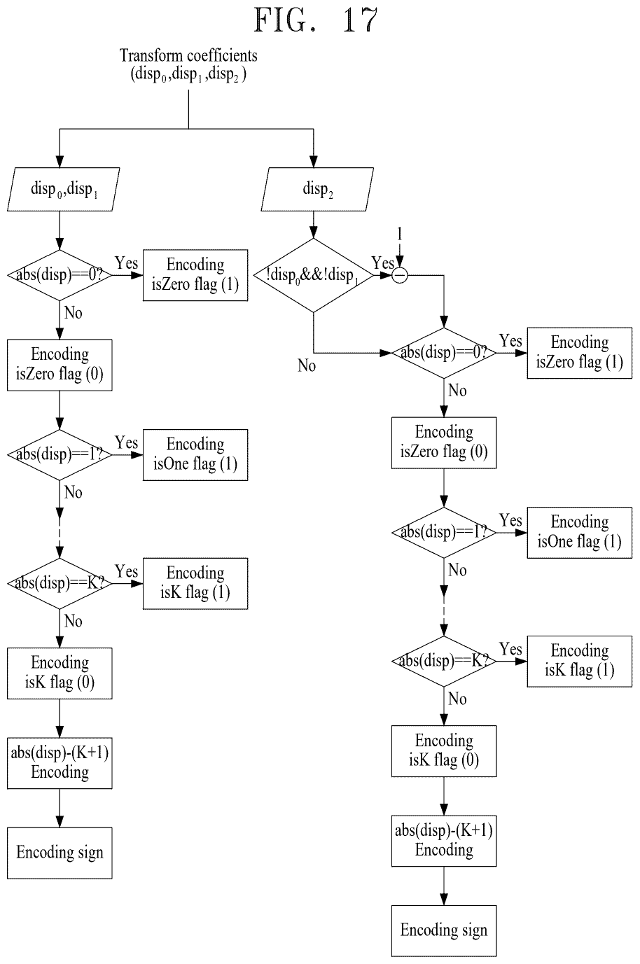

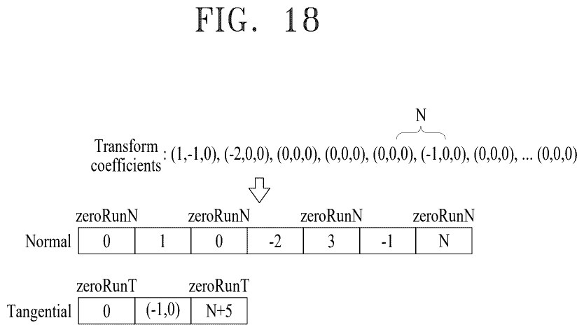

In FIG. 16, if one or more components of the transform coefficients (disp₀, disp₁, disp₂) have a value different from 0, the transform coefficient encoding may be performed as illustrated in FIG. 17.

FIG. 17 is a flowchart illustrating an example method of zero run-length encoding of transform coefficients according to embodiments.

In FIG. 17, the transform coefficients disp₀, disp₁, and disp₂ may be values of x, y, and z, or may be values of n, t, and bt.

In other words, when one or more of the components of the three axes have a value different from 0, the transform coefficients encoding may be performed as illustrated in FIG. 17.

Also, in FIG. 17, three flags, namely, the isK flag, the isZero flag, and the isOne flag may be used for zero run-length encoding. Zero run-length coding is a method of compressing data by reducing the repetition of consecutive bit values. In the present disclosure, isN (isZero, isOne, . . . , isK) is a flag for determining whether the magnitude (abs(disp)) of the transform coefficient is equal to N.

According to embodiments, the isK flag (Is-Known Flag) indicates when the value of the next bit is. This isK flag is set to either 1 or 0. When set to 1, it indicates the next bit value is a known value. For example, in the case of consecutive zeros, the isK flag is set to 1, and the value of the next bit is set to the known value, 0.

According to embodiments, the isZero flag that indicates the number of consecutive 0-bits. The isZero flag is set to 0 or a positive integer. When the isK flag is set to 1 and the value of the next bit is 0, the isZero flag is set to a value representing the number of consecutive 0's. This is used to compress the sequence of 0's.

According to embodiments, the isOne flag indicates the number of consecutive 1-bits. The isOne flag is also set to zero or a positive integer. When the isK flag is set to 1 and the value of the next bit is 1, the isOne flag is set to a value representing the number of consecutive 1's. This is used to compress the sequence of 1's.

Zero run-length coding may use the isK flag, isZero flag, and isOne flag described above to efficiently represent a bit pattern of consecutive 0's and 1's to compress data.

In FIG. 17, abs(disp) denotes the absolute value of the displacement vector transform coefficient. The displacement vector transform coefficient may be a positive integer or 0, representing the number of consecutive 0's or 1's indicated by the isZero flag or the isOne flag. In other words, abs(disp) represents the absolute value of the displacement vector transform coefficient (disp), and is therefore always an integer greater than or equal to 0.

In FIG. 17, the transform coefficients may be encoded sequentially for each component (disp₀, disp₁, disp₂).

According to embodiments, when abs(disp) is 0, the isZero flag may be encoded as 1. When abs(disp) is 1, the isZero flag may be encoded as 0. Further, when abs(disp) is 1, the isOne flag may be encoded as 1. When abs(disp) is 1, the isOne flag may be encoded as 0.

According to embodiments, the isN flag is used to check whether the currently encoded coefficient is equal to N (N=0, 1, . . . , K, where K is a positive integer). When the encoded coefficient is equal to N, the isN flag may be encoded and the operation may be terminated.

In FIG. 17, when all the values up to the isk flag are 0, abs(disp)-(K+1) may finally be entropy-encoded.

When both disp₀ and disp₁ are 0, disp₂, which is encoded last in order, may always be derived to be greater than or equal to 0. Thus, disp₂−1 may be encoded.

According to embodiments, when the coordinate system of the displacement vector is the (n, t, bt) coordinate system, zero run-length encoding may be performed on the normal component (n) and the tangential components (t, bt), respectively. In this case, the transform coefficients of the normal component and the tangential components may be encoded in parallel.

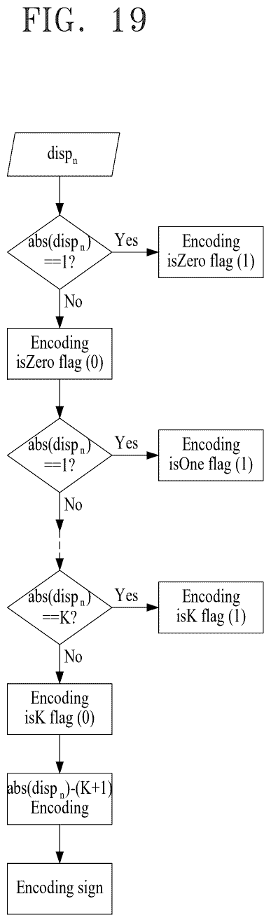

FIG. 18 is a diagram illustrating an example of zero run-length encoding in the (n, t, bt) coordinate system according to embodiments.

According to embodiments, when the coordinate system of the displacement vector is the normal coordinate system, zero run-length encoding may be performed on the normal component (n) and the tangential components (t, bt) separately according to an agreement between the encoder (i.e., the transmission device)/decoder (i.e., the reception device), or a 1-bit flag (i.e., separate_zero_run_flag) may be used to determine whether to perform zero run-length encoding on the normal component (n) and the tangential components (t, bt) separately. For example, separate_zero_run_flag set to 1 may indicate that the normal component and the tangential components are each subjected to zero run-length encoding, while separate_zero_run_flag set to 0 may indicate that the normal component and the tangential components are subjected to zero run-length encoding at once. In this case, when separate_zero_run_flag is set to 1, the reception device or decoder may perform zero run-length decoding on the normal component and the tangential components, respectively. When separate_zero_run_flag is set to 1, the reception device or decoder may perform zero run-length decoding on the normal component and the tangential components at once.

In FIG. 18, when the displacement vector transform coefficients (n, t, bt) are (1,−1,0), (−2,0,0), (0,0,0), (0,0,0), (0,0,0), (0,0,0), (−1,0,0), and N terms of (0,0,0), the normal is composed of (1), (−2), (0), (0), (0), (0), (−1), N terms of (0). In this case, the value of zeroRun for (1) is 0 because (1) is not followed by no 0; the value of zeroRun for (−2) is 3 because (−2) is followed by three 0's; the value of zeroRunN for (−1) is N because (−1) is followed by N O's.

Also, when the displacement vector transform coefficients (n, t, bt) are (1,−1,0), (−2,0,0), (0,0,0), (0,0,0), (0,0,0), (0,0,0), (−1,0,0), and N terms of (0,0,0), the tangential and bi-tangential are composed of (−1, 0), (, 0, 0), (0, 0), (0, 0), (0, 0), (0, 0), (0, 0), N terms of (0, 0). In this case, (−1,0) is followed by 5+N terms of (0,0), and therefore the value of zeroRunT is N+5.

Even in this case, zero run-length coding may be performed on a per-LoD or per-sLoD basis. Alternatively, zero run-length coding may be performed on the normal and tangential components separately up to a specific LoD level or a specific sLOD level, and then zero run-length encoding may be performed on the normal and tangential components at once for the remaining LoD levels (or sLoD levels). For example, zero run-length coding may be performed on the normal and tangential components separately for LoDs (or sLoDs) 0 to k. From LoD (or sLoD) k+1, zero run-length encoding may be performed on the normal and tangential components at once. Here, k may be determined by an agreement made by the encoder/decoder or may be determined by signaling.

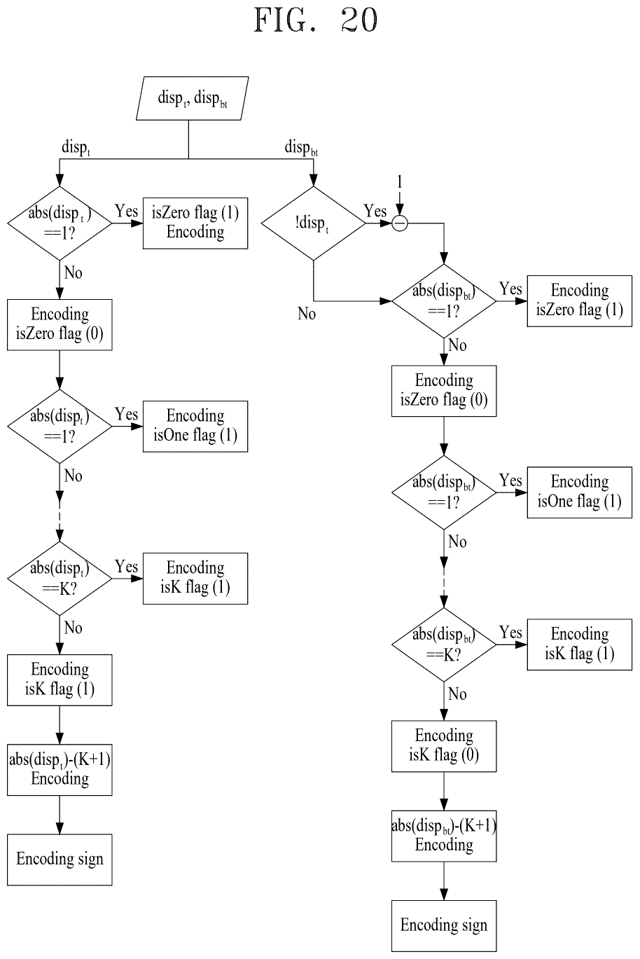

FIG. 19 is a flowchart illustrating an example of zero run-length encoding of displacement vector transform coefficients of a normal component in the (n, t, bt) coordinate system according to embodiments.

FIG. 20 is a flowchart illustrating an example of zero run-length encoding of displacement vector transform coefficients of a tangential component in the (n, t, bt) coordinate system according to embodiments.

Specifically, when zero run-length encoding is performed on the normal component (n) and the tangential components (t, bt) separately, the displacement vector transform coefficient of the normal component, dispn, may be subjected to zero run-length encoding as shown in FIG. 19, and the displacement vector transform coefficients of the tangential component, disp and dispbt, may be subjected to zero run-length encoding as shown in FIG. 20.

Also in FIGS. 19 and 20, the isK flag indicates what the value of the next bit is. The isK flag is set to 1 or 0. When set to 1, it indicates that the value of the next bit is a known value. For example, for consecutive 0's, the isK flag is set to 1, and the value of the next bit is set to the known value, 0.

The isZero flag indicates the number of consecutive 0-bits. The isZero flag is set to 0 or a positive integer. When the isk flag is set to 1 and the value of the next bit is 0, the isZero flag is set to a value representing the number of consecutive 0's. This is used to compress the sequence of 0's.

Also, the isOne flag indicates the number of consecutive 1-bits. The isOne flag is also set to zero or a positive integer. When the isK flag is set to 1 and the value of the next bit is 1, the isOne flag is set to a value representing the number of consecutive 1's. This is used to compress the sequence of l's.

In FIGS. 19 and 20, abs(dispn) indicates the absolute value of the displacement vector transform coefficient of the normal component (n), abs(dispt) indicates the absolute value of the displacement vector transform coefficient of the tangential component (t), and abs(dispbt) indicates the absolute value of the displacement vector transform coefficient of the bi-tangential component (bt). In other words, the displacement vector transform coefficient of each component may be a positive integer or 0, representing the number of consecutive 0's or 1's indicated by the isZero flag or the isOne flag. In other words, abs(dispn) represents the absolute value of the displacement vector transform coefficient (dispn), and is therefore always an integer greater than or equal to 0.

According to embodiments, when abs(dispn) is 0, the isZero flag may be encoded as 1. When abs(dispn) is 1, the isZero flag may be encoded as 0. Further, when abs(dispn) is 1, the isOne flag may be encoded as 1. When abs(dispn) is 1, the isOne flag may be encoded as 0. The same rules apply for abs(dispt) and abs(dispbt).

According to embodiments, the isN flag is used to check whether the currently encoded coefficient is equal to N (N=0, 1, . . . , K, where K is a positive integer). When the encoded coefficient is equal to N, the isN flag may be encoded and the operation may be terminated.

In FIGS. 19 and 20, when all the values up to the isk flag are 0, abs(disp)-(K+1) may finally be entropy-encoded.

When dispt is 0, dispbt, which is encoded last in order, may always be derived to be greater than or equal to 0. Thus, dispbt−1 may be encoded.

According to embodiments, even when performing zero run-length encoding, the LoD determined by the mesh subdivider 11017, or a separate level sLoD for scalable support may be defined, and zero run-length encoding may be performed on the displacement vector transform coefficients per level (LoD level or sLoD level). This may allow for scalable encoding and decoding of the displacement vectors.

As described above, in the second embodiment of the method of encoding displacement vectors by the displacement vector encoder 11026, zero run-length encoding may be performed only on the displacement vector transform coefficients of the (x,y,z) components or the (n, t, bt) components at a specific LoD level or a specific sLoD level using a scalable zero run-length encoder in zero run-length encoding of the displacement vector transform coefficients of the (x, y, z) components or (n, t, bt) components. In the case of LoD2, for example, zero run-length coding may be performed on the displacement vector transform coefficients of the (x, y, z) components or the (n, t, bt) components corresponding to LoD2. In the case of sLoD3, for example, zero run-length coding may be performed on the displacement vector transform coefficients of the (x, y, z) components or the (n, t, bt) components corresponding to sLoD3.

### Third Embodiment of Displacement Vector Encoding Method

According to embodiments, zero run-length encoding may be performed by bundling the displacement vector transform coefficients of multiple frames within a group of frames (GOF). In other words, two or more frames in the GOF may be grouped and zero run-length encoding may be performed by bundling the displacement vector transform coefficients on a per-group basis. For example, every two frames in the GoF may be grouped together, and then zero run-length encoding may be performed by bundling the displacement vector transform coefficients on a per-group basis.

In the present disclosure, the packing method may vary depending on the features of the frames being grouped.

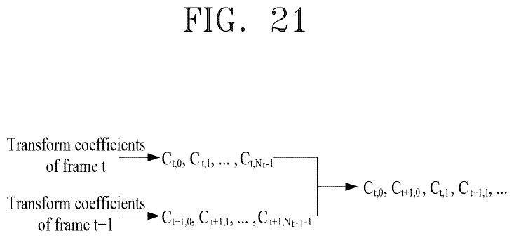

FIG. 21 illustrates an example of packing displacement vector transform coefficients of two frames in an interleaving manner according to embodiments.

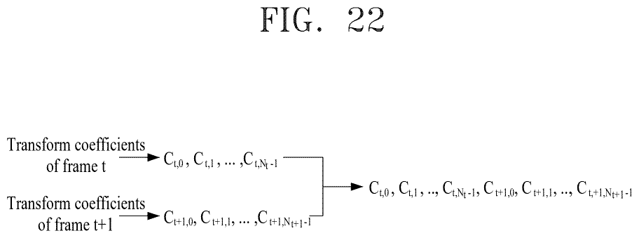

FIG. 22 illustrates an example of packing displacement vector transform coefficients of two frames in a serial manner according to embodiments.

According to embodiments, when the vertices in the frames being grouped have a 1-to-1 mapping relationship, the displacement vector transform coefficients having the same vertex index may be interleaved as shown in FIG. 21 to reconfigure the transform coefficients, and zero run-length encoding may be performed on the reconfigured transform coefficients. For example, suppose that the transform coefficients of frame t and the transform coefficients of frame t+1 are packed (or grouped). When the transform coefficients of frame t are C_{t.0}, C_{t.1}, . . . , C_{t,nt-1}, and the transform coefficients of frame t+1 are C_{t+1.0}, C_{t.1.1}, . . . , C_{t+1.nt-1}, the input sequence for zero run-length coding may be C_{t.0}, C_{t. 1.0}, C_{t.1}, C_{t.1.1}, . . . , C_{t,nt-1}, and C_{t. 1,nt-1} through interleaving.

According to embodiments, when the vertices in the frames being grouped do not have a 1-to-1 mapping relationship, the transform coefficients may be sorted per LoD level using a method defined by an agreement between the encoder/decoder based on the reconstructed vertex geometry information related to each frame, and the sorted transform coefficients may be combined through interleaving. Then, zero run-length encoding may be performed. As a sorting method, 3D Morton code may be used, for example. Further, the displacement vector transform coefficients may be reconfigured by sorting the transform coefficients in frame order rather than in an interleaving manner, as shown in FIG. 22, and zero run-length encoding may be performed on the reconfigured transform coefficients (in, for example, a serial manner). For example, suppose that the transform coefficients of frame t and the transform coefficients of frame t+1 are packed (or grouped). When the transform coefficients of frame t are C_{t.0}, C_{t.1}, . . . , C_{t,nt-1}, and the transform coefficients of frame t+1 are C_{t-1.0}, C_{t.1.1}, . . . , C_{t.1.nt-1}, the input sequence for zero run-length coding may be C_{t.0}, C_{t.1}, . . . , C_{t,nt-1}, C_{t1.0}, C_{t.1.1}, . . . , and Cₜₙₜ₋₁ in a serial manner.

According to embodiments, a method of packing the displacement vector transform coefficients of multiple frames may be signaled to the decoder through signaling information (e.g., displacement_packing_method). That is, the displacement_packing_method may dictate the packing method for the transform coefficients of each frame when the displacement vector transform coefficients of multiple frames are encoded in a bundle. For example, displacement_packing_method set to 0 indicates that the frames are packed in an interleaved manner, while displacement_packing_method set to 1 indicates that the frames are packed in a serial manner.

According to embodiments, the transform coefficients of multiple (or two or more) frames combined in an interleaving or serial manner may be subjected to zero run-length coding per LoD level (or sLoD level).

In this case, zero run-length encoding may also be performed by bundling the displacement vector transform coefficients of frames on a per-LoD or per-sLoD basis. For example, zero run-length encoding may be performed by bundling the displacement vector transform coefficients corresponding to LoD1 in two frames in an interleaved manner or a serial manner. As another example, zero run-length encoding may be performed by bundling the displacement vector transform coefficients corresponding to sLoD2 in the two frames in an interleaved manner or a serial manner. Alternatively, zero run-length encoding may be performed on a level-by-level basis up to a specific LoD level or a specific sLOD level. For the remaining LoD levels (or sLoD levels) up to the last LoD level (or sLoD level), zero run-length encoding may be performed all at once. For example, for LoDs (or sLoDs) 0 to k, zero run-length coding may be performed on a per-LoD (or sLoD) level basis. For LoD (or sLoD) level k+1 to the last LoD (or sLoD) level. zero run-length coding may be performed once.

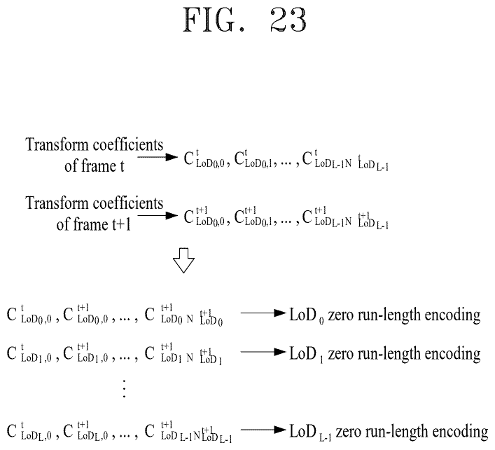

FIG. 23 illustrates an example of zero run-length encoding of displacement vector transform coefficients of two interleaved frames per LoD level according to embodiments. In FIG. 23,

$${N}_{{LoD}_{0}}^{t}$$

is less than

$${N}_{{LoD}_{0}}^{t + 1} ( {N}_{{LoD}_{0}}^{t} < {N}_{{LoD}_{0}}^{t + 1} ) .$$

In other words, FIG. 23 illustrates an example of performing zero run-length encoding by interleaving the displacement vector transform coefficients corresponding to LoD0 in two frames, performing zero run-length encoding by interleaving the displacement vector transform coefficients corresponding to LoD1 in the two frames, and performing zero run-length encoding by interleaving the displacement vector transform coefficients corresponding to LoD_{L-1} in the two frames.

In this case, the unit in which zero run-length encoding is performed independently may be a LoD level, or may be an sLoD level defined for scalability.

On the other hand, the level-based reconstructed mesh (or reconstructed deformed mesh) from the level-specific mesh reconstructor 11025 has reconstructed vertices, vertex connectivity information, texture coordinates, and inter-textual coordinate connectivity information. That is, the level-specific mesh reconstructor 11025 may subdivide the reconstructed base mesh generated by the base mesh reconstructor 11020 and add the reconstructed displacement vectors from the displacement vector reconstructor 11024 to generate a reconstructed deformed mesh for each LoD (or sLoD) level.

According to embodiments, the texture map generator 11027 may regenerate a texture map of the current mesh based on the texture map (also referred to as an attribute map) of the original mesh and the reconstructed mesh from the level-specific mesh reconstructor 11025 as inputs.

For example, color mapping to u, v coordinates in the texture coordinate space may be performed through a texture color mapping process for all u, v coordinates.

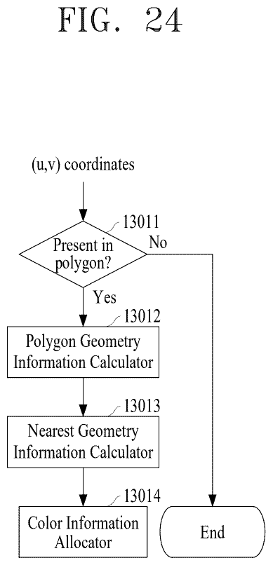

FIG. 24 is a diagram illustrating an example of texture color mapping by a texture map generator according to embodiments. Each component in FIG. 24 corresponds to hardware, software, a processor, and/or a combination thereof.

According to embodiments, the texture color mapping process is performed by the texture color mapper of the texture map generator 11027. According to embodiments, the texture color mapper may include a determination unit 13011, a polygon geometry calculator 13012, a nearest geometry calculator 13013, and a color information allocator 13014.

According to embodiments, for all input u, v coordinates (e.g., texture coordinates of the original mesh), the determination unit 13011 determines whether the coordinates are present within a polygon in the texture coordinate space based on the texture connectivity information.

If it is determined that the coordinates are present in the polygon, the polygon geometry information calculator 13012 calculates the geometry information (x, y, z) about the polygon for the u, v coordinates present in the polygon. A representative value of the polygon may be calculated as the geometry information about the polygon. The representative value may be an average, centroid, or the like.

According to embodiments, the nearest geometry information calculator 13013 calculates the polygon or vertex of the original mesh that is nearest the geometry information about the polygon calculated by the polygon geometry information calculator 13012 or the representative value of the geometry information about the polygon.

According to embodiments, the color information allocator 13014 allocates the texture map color of the current u,v position according to the color of the nearest polygon or vertex calculated by the nearest geometry information calculator 13013. Once the nearest polygon is calculated, the texture map color at the current u, v coordinates may be allocated based on the average value of the polygon, for example.

According to embodiments, when regenerating the texture map through the texture color mapper as described above, the texture map generator 11027 may regenerate the texture map for each LoD (or sLoD) level based on the texture map (or attribute map) of the original mesh and the deformed base mesh (or reconstructed deformed mesh) reconstructed for each LoD (or sLoD) level by the level-specific mesh reconstructor 11025. According to embodiments, the texture map generator 11027 may allocate per-vertex color information from the texture map of the original mesh to the texture coordinates of the reconstructed base mesh (or reconstructed deformed mesh) for each LoD (or sLoD) level. According to embodiments, the texture map generator 11027 may generate a texture map video by bundling the reconstructed texture maps per GoF in each frame.

In the present disclosure, the texture map of the mesh may be generated for each LoD (or sLoD) by the texture map generator 11027, and then scalable encoding may be performed thereon per LoD (or sLoD) by the texture map encoder 11028 using a scalable 2D video codec.

According to embodiments, when defining the base mesh as LoD₀ and the mesh with n mesh subdivisions applied to the base mesh as a LoD, mesh, the texture map generator 11027 may generate LoD-specific texture maps by performing a texture color mapping process on the mesh of each LoD as shown in FIG. 24. To this end, the texture map encoder 11028 may be provided with subdivision-related information and LoD-related information and/or sLoD-related information defined in the mesh subdivider 11017. Further, the texture map encoder 11028 may be provided with LoD-specific information and/or sLoD-specific information applied to the displacement vector scalable encoding by the displacement vector encoder 11026.

According to embodiments, the texture map generated for each LoD may be downsampled or subsampled on a level-by-level basis and may then be encoded by the texture map encoder 11028.

For example, when L LoDs are configured from LoD₀ to LoD_{L-1}, the texture map for the n-th LoD may be downsampled or subsampled to a size of

$$\frac{W}{{2}^{L - n}} \times \frac{H}{{2}^{L - n}} .$$

According to embodiments, sLoD levels for scalable support may be defined separately from the LoD levels determined by the mesh subdivider 11017, and texture map generation and downsampling (or subsampling) may be performed on a per-sLoD level basis.

According to embodiments, when mesh levels are determined on a per sLoD level basis, the texture map for the nth level of k levels may be encoded by downsampling or subsampling to a size of

$$\frac{W}{{2}^{k - n}} \times \frac{H}{{2}^{k - n}} .$$

For example, a texture map of the n-th sLoD level out of k sLoD levels may be encoded by the texture map encoder 11028 after being downsampled or subsampled to a size of

$$\frac{W}{{2}^{k - n}} \times \frac{H}{{2}^{k - n}} .$$

That is, when downsampling (or subsampling) is performed for each level, the downsampling (or subsampling) method may be determined based on the presence and/or number of triangles in the T×T region currently being downsampled based on the texture coordinates and texture connectivity information. Here, the level may be a LoD level or an sLoD level.

According to embodiments, when multiple polygons (e.g., triangles) are present in the T×T region of the n-th level texture map, the downsampled color of the n−1-th level texture map may be calculated based on the average or weighted sum of the surface colors of the triangles.

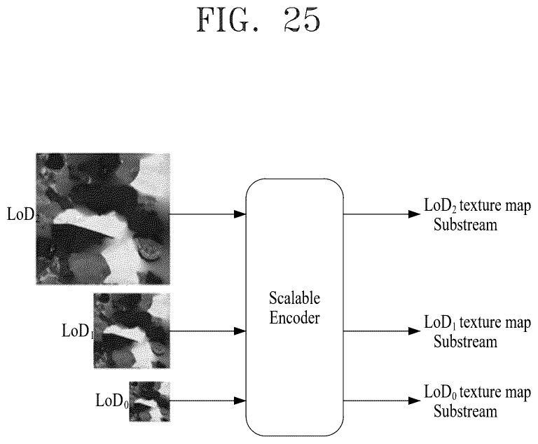

In FIG. 25, LoD2, LoD1, and LoD0, which are input to the scalable encoder, are examples of texture maps that are downsampled or subsampled according to the LoD level by the texture map generator 1127.

According to embodiments, when one polygon is present in the T×T region of the n-th level texture map, the downsampled color of the n−1-th level texture map may be calculated based on the surface color of the polygon.

According to embodiments, the texture map generated for each level may be padded based on the color values of the surrounding texture maps when corresponding coordinates are not present within the polygon based on the texture coordinate connectivity information for all u,v coordinates. According to embodiments, push-pull padding may be used, for example.

According to embodiments, even when one texture map is generated instead of texture maps for the respective levels, the texture map may be downsampled, wherein the downsampled size may be configured as an index and signaled to the receiving side.

According to embodiments, the texture map that has been downsampled (or subsampled) on a per-level basis may be encoded by the 2D scalable video codec in the texture map encoder 11028.

FIG. 25 illustrates examples of compressing a texture map generated per level using a scalable video codec according to embodiments.

For example, the texture map at the N-th LoD may be encoded with reference to a texture map at a lower LoD than the current LoD (e.g., inter layer prediction).

Alternatively, the texture maps generated for the respective levels may be encoded using independent video codecs therefor. For example, when the number of LoD levels is 4, 4 independent video codecs may be used to encode the texture maps at the corresponding LoDs. As another example, when the number of sLoD levels is 2, 2 independent video codecs may be used to encode the texture map at the corresponding sLoDs.

As such, the texture map video per LoD (or sLoD) level generated by the texture map generator 11027 may be encoded using the scalable 2D video codec in the texture map encoder 11028. The per-LoD (or sLoD) level texture map substream (or texture map video bitstream) generated by the encoding is transmitted to the multiplexer (not shown).

According to embodiments, the texture map video encoder may be a video encoder (e.g., VVC, HEVC, etc.), an encoder based on entropy coding, or the like. As a method of selecting the texture map video encoder, a texture map encoder agreed upon by the encoder (i.e., transmitting side)/decoder (i.e., receiving side) may be used, or the type of texture map encoder selected by the encoder on the transmitting side may be transmitted to the decoder on the receiving side.

In one embodiment, the LoD (or sLoD) level applied to the encoding of the displacement vector is the same as the LoD (or sLoD) level applied to the encoding of the texture map. For example, when the displacement vector corresponding to LoD3 is encoded using a 2D video codec, the texture map corresponding to LoD3 is encoded using a 2D video codec. As another example, when the displacement vector corresponding to sLoD1 was encoded in a 2D video codec method, the texture map corresponding to sLoD1 may be encoded in a 2D video codec method.

According to embodiments, the multiplexer may multiplex the input base mesh bitstream, displacement vector bitstream, and texture map bitstream into a single bitstream and transmit the single bitstream to the receiver via a transmitter (not shown). Alternatively, the base mesh bitstream, displacement vector bitstream, and texture map bitstream may be encapsulated into a file/segment and transmitted to the receiver via the transmitter.

According to embodiments, the bitstreams multiplexed by the multiplexer may be transmitted over a network and/or stored on a digital storage medium. The network may include a broadcast network and/or a communication network, and the digital storage medium may include various storage media, such as USB, SD, CD, DVD, Blu-ray, HDD, SSD, and the like.

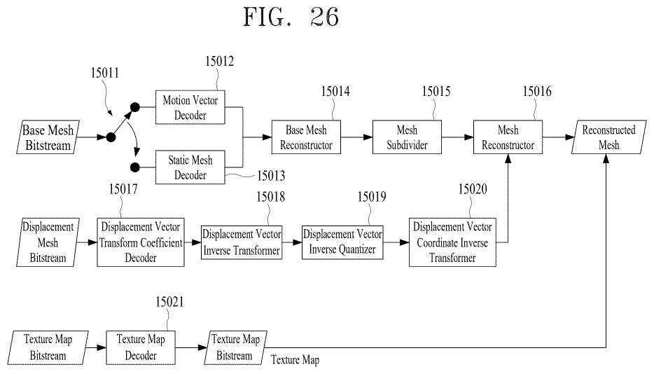

FIG. 26 is a diagram illustrating a mesh data reception device according to embodiments. In the present disclosure, the reception device of FIG. 26 may be referred to as a decoder.

FIG. 26 corresponds to the reception device 110 or mesh video decoder 113 of FIG. 1, the decoder of FIG. 11 or 12, the reception device of FIG. 14, and/or a corresponding receiving decoding device. Each component of FIG. 26 corresponds to hardware, software, a processor, and/or a combination thereof. The reception (decoding) operation of FIG. 26 may follow a reverse process to the corresponding process of the transmission (encoding) operation of FIG. 15. In FIG. 26, the order of exclusion of the blocks may be varied, some blocks may be omitted, and some new blocks may be added.

According to embodiments, the bitstream of mesh data received by the receiver (not shown) is file/segment-decapsulated and then demultiplexed into a base mesh bitstream, a displacement vector bitstream, and a texture map bitstream by a demultiplexer (not shown). In the case where inter-frame encoding (i.e., inter-encoding) has been applied to the current mesh, the base mesh bitstream may be a motion vector bitstream.

According to embodiments, the base mesh bitstream is output to a motion vector decoder 15012 or a static mesh decoder 15013 via a switching unit 15011.

For example, in the case where inter-frame encoding (i.e., inter-encoding) has been applied to the current mesh, the base mesh bitstream, i.e., the motion vector bitstream, is received, demultiplexed, and output to the motion vector decoder 15012 via the switching unit 15011. As another example, in the case where intra-frame encoding (i.e., intra-encoding) has been applied to the current mesh, the base mesh bitstream is received, demultiplexed, and output to the static mesh decoder 15013 via the switching unit 15011. Here, the motion vector decoder 15012 may be referred to as a motion decoder.

According to embodiments, the motion vector decoder 15012 may perform decoding on the motion vector bitstream on a vertex-by-vertex or subgroup-by-subgroup basis.

According to embodiments, the motion vector decoder 15012 may use a previously decoded motion vector as a predictor and add the same to the difference motion vector (i.e., residual motion vector) decoded from the bitstream to reconstruct a final motion vector. That is, the motion vector decoder 15012 may decode a vertex- or subblock-wise difference motion vector (or residual motion vector) through the motion vector bitstream and perform connectivity information-based prediction using the previously decoded motion vector as a predictor to decode the motion vector by adding the residual motion vector to the prediction.

According to embodiments, the static mesh decoder 15013 may decode the base mesh bitstream to reconstruct connectivity information, vertex geometry information, texture coordinates (i.e., attribute geometry information), normal information, and the like related to the base mesh.

According to embodiments, the base mesh reconstructor 15014 may reconstruct the current base mesh based on the decoded motion vectors or the decoded base mesh. For example, in the case where inter-frame encoding has been applied to the current mesh, the base mesh reconstructor 15014 may add the decoded (or reconstructed) motion vectors to the reference base mesh and perform inverse quantization to generate the reconstructed base mesh (i.e., the current base mesh). As another example, in the case where intra-frame encoding has been applied to the current mesh, the base mesh reconstructor 15014 may perform inverse quantization on the base mesh decoded (or reconstructed) by the static mesh decoder 15012 to generate the reconstructed base mesh (i.e., the current base mesh).

According to embodiments, the mesh subdivider 15015 may subdivide the base mesh to generate additional vertices. In the present disclosure, the geometry information connectivity information, texture coordinate connectivity information, and texture coordinates are may be implicitly inferred and generated according to the subdivision method.

According to embodiments, the mesh subdivider 15015 may perform subdivision using a method such as mid-edge, Loop, Catmul&Clark, or the like.

According to embodiments, the mesh subdivision may be performed by the mesh subdivider 15015 n times based on a user parameter or an agreement made by the encoder/decoder. According to embodiments, when defining the vertices of the base mesh as R₀, the vertices newly generated by performing the subdivision once as R1, . . . , and the vertices generated by performing the subdivision n times as Rn, LoDn may be defined as shown in Equation 2 below.

$${LoD}_{n} = {R}_{0} ⋃ {R}_{1} ⋃ , … , ⋃ {R}_{n} \qquad [ Equation 2 ]$$

According to embodiments, the displacement vector transform coefficient decoder 15017 may decode the demultiplexed displacement vector bitstream as a video bitstream using a video codec or perform zero run-length decoding thereon.

According to embodiments, the displacement vector transform coefficient decoder 15017 may decode and reconstruct the displacement vector by the inverse process of at least one of the first to third embodiments of the displacement vector encoding method on the transmitting side.

According to embodiments, the displacement vector transform coefficient decoder 15017 may decode the displacement vector by decoding a displacement vector transform coefficient for a specific LoD (or sLoD) level that is received, or a displacement vector transform coefficient for a specific LoD (or sLoD) level based on the processing power or capability of the receiver.

### First Embodiment of Displacement Vector Decoding Method

According to embodiments, displacement vector transform coefficient video encoded using a video codec on the transmitting side is decoded using the same video codec by the displacement vector transform coefficient decoder 15017 of the reception device.

According to embodiments, the displacement vector transform coefficient decoder 15017 may reconstruct the displacement vector transform coefficient video, which is defined by an agreement between the encoder/the decoder based on levels of the LoD determined through the mesh subdivider 15015 or levels of the LoD (i.e., sLoD) defined for scalable coding, or configured per level of LoD (or sLoD) configured from received information, using a 2D scalable decoder. That is, 2D video decoding may be performed only for displacement vector transform coefficients of a specific LoD (or sLoD) level with reference to signaling information (e.g., at least one of num_scalable_LoD_minus1, LoD_level_idx, sLoD_index, or sLoD_enable_flag).

According to embodiments, the displacement vector transform coefficients decoder 15017 may decode the per-level displacement vector transform coefficient videos starting from a lower level, by parsing sub-bitstreams. The decoding may be performed through an inter-layer reference that references video at a lower level than the current level in performing the decoding. Here, the level may be a LoD level or an sLoD level.

According to embodiments, the displacement vector transform coefficient decoder 15017 may perform the mesh scalable function by decoding the displacement vector transform coefficient video up to a specific level of the level-specific substreams.

According to embodiments, the displacement vector transform coefficient decoder 15017 for 2D scalable video decoding may be a video decoder (e.g., VVC, HEVC), a decoder based on entropy coding, or the like.

### Second Embodiment of Displacement Vector Decoding Method

According to embodiments, the displacement vector transform coefficient decoder 15017 decodes displacement vector transform coefficients (disp₀, disp₁, and disp₂) in the (x, y, z) or (n, t, bt) coordinate system.

The displacement vector transform coefficients may be decoded using a zero run-length decoder. According to embodiments, zero run-length decoding may be performed on the three transform coefficients (disp₀, disp₁, and disp₂) all at once. Alternatively, when the coordinate system of the displacement vector transform coefficients is the normal coordinate system, the normal component (n) and the tangential components (t, bt) may be zero run-length decoded by a zero run-length decoder, respectively.

In this case, zero run-length decoding may be performed on the three transform coefficients for a specific LoD (or sLoD) level all at once, with reference to the signaling information. Alternatively, when the coordinate system of the displacement vector transform coefficients is the normal coordinate system, the normal component (n) and the tangential components (t, bt) for a specific LoD (or sLoD) level may each be zero run-length decoded.

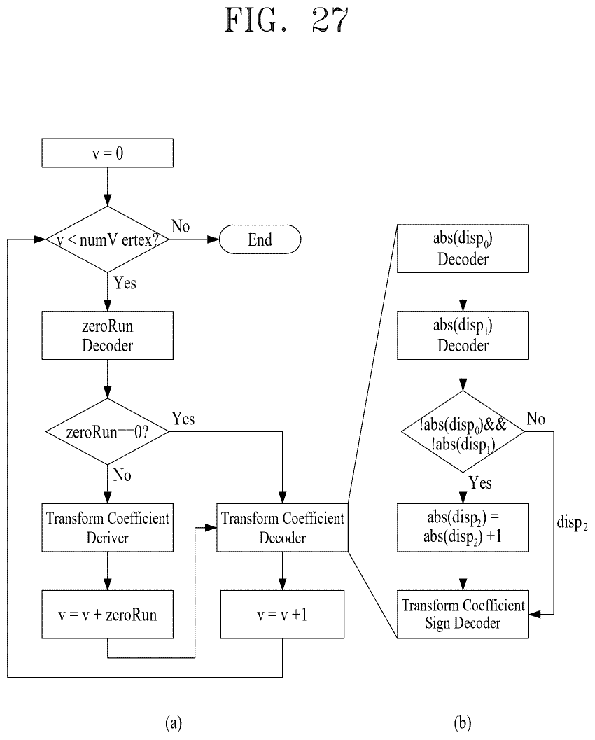

FIG. 27-(a) is a flowchart illustrating an example of zero run-length decoding of displacement vector transform coefficients according to embodiments.

FIG. 27-(b) is a flowchart illustrating an example of decoding of the absolute values of displacement vector transform coefficients according to embodiments.

In particular, FIGS. 27-(a) and 27-(b) illustrate examples of a case where the displacement vector transform coefficients are decoded into a single zero run-length.

In FIGS. 27-(a) and 27-(b), the zero run-length decoding is repeated as many times as the number of vertices (num Vertex). In particular, the three transform coefficients (disp₀, disp₁, disp₂) are sequentially subjected to zero run-length decoding component by component.

According to embodiments, in FIG. 27-(a), the zeroRun decoder parses the value of zeroRun from the displacement vector bitstream, and the transform coefficient deriver derives the value of the transform coefficients for vertices corresponding to the magnitude of zeroRun as 0 according to the parsed value of zeroRun (i.e., when the value of zeroRun is not 0). When the parsed value of zeroRun is 0 or when the value of zeroRun is derived to be 0, the transform coefficient decoder performs decoding on the absolute values of the three transform coefficients. In this case, for disp₂, which is decoded last in order, decoding of the sign of the transform coefficient for disp₂₊₁ may be performed.

When the coordinate system of the displacement vectors is the (n, t, bt) coordinate system, zero run-length decoding may be performed on the normal component (n) and the tangential components (t, bt), respectively.

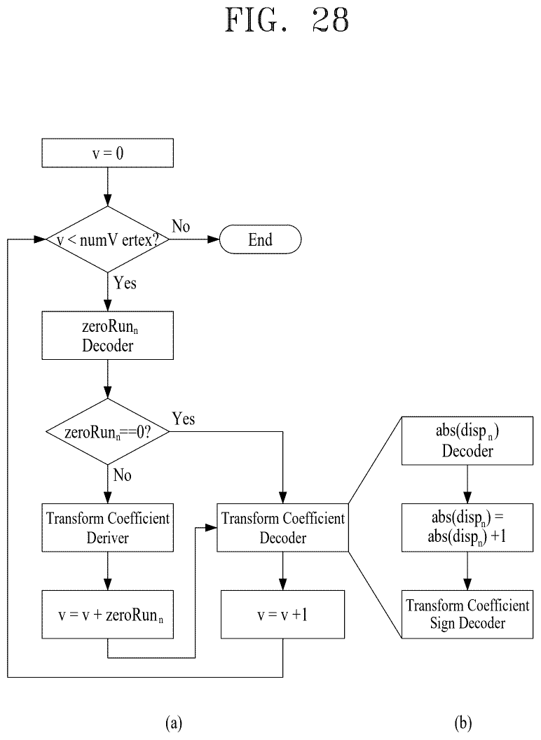

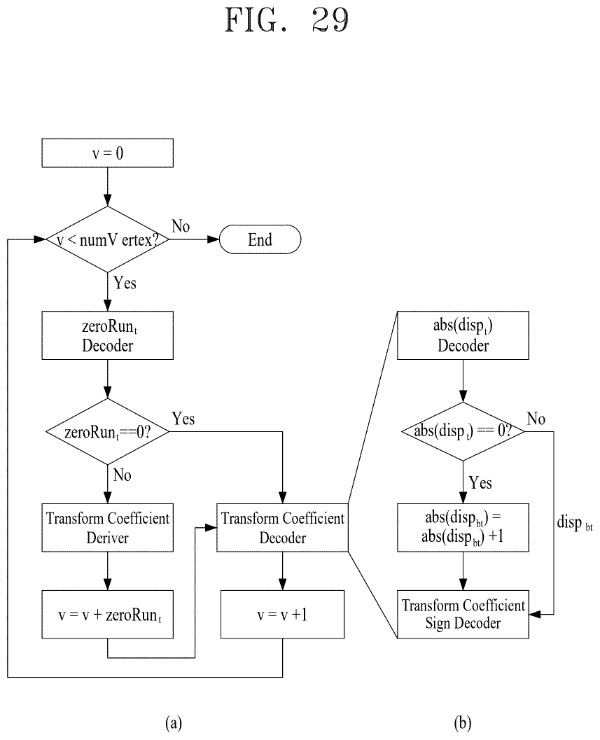

FIGS. 28-(a) and 28-(b) are flowcharts illustrating an example of zero run-length decoding of displacement vector transform coefficients of a normal component in a (n, t, bt) coordinate system according to embodiments.

FIGS. 29-(a) and 29-(b) are flowcharts illustrating an example of zero run-length decoding of displacement vector transform coefficients of tangential components in a (n, t, bt) coordinate system according to embodiments.

That is, when the normal component and the tangential components are decoded through the zero run-length decoder, respectively, embodiments of the transform coefficient decoder are configured as shown in FIGS. 28-(a) and 29-(a). In particular, FIG. 28-(b) is an example of a detailed decoding process for the displacement vector transform coefficients of the normal component performed by the transform coefficient decoder of FIG. 28-(a), and FIG. 29-(b) is an example of a detailed decoding process of the displacement vector transform coefficients for the tangential components performed by the transform coefficient decoder of FIG. 29-(a).

According to embodiments, a 1-bit flag (e.g., separate_zero_run_flag) included in the signaling information may determine whether to perform zero run-length decoding on the normal component and the tangential components separately. According to embodiments, separate_zero_run_flag as a flag to determine whether to perform separate_zero run-length decoding on the normal and tangential components separately. When separate_zero_run_flag is set to 1, zero run-length decoding may be performed on the normal component and the tangential components separately. When separate_zero_run_flag is set to 0, zero run-length decoding may be performed on the normal component and the tangential components at once.

According to embodiments, for LoD (or sLoD) levels 0 to k, zero run-length decoding may be performed on the normal and tangential components separately. For LoD (or sLoD) levels k+1 and higher, the normal and tangential components may be decoded at once, i.e., using one zero run-length decoder.

In other words, through the processes in FIGS. 28 and 29, the transform coefficients of the normal and tangential components may be decoded in parallel.

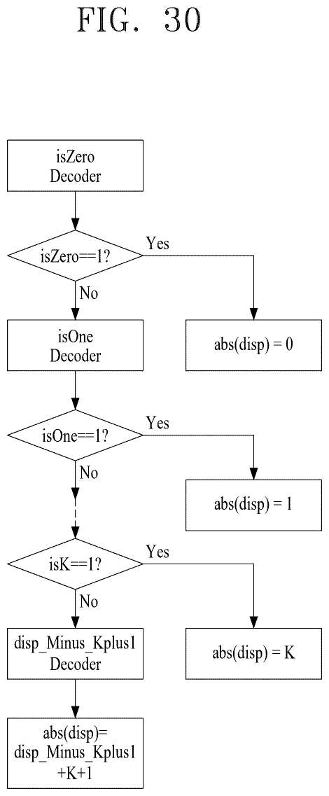

FIG. 30 is a flowchart illustrating entropy decoding of the absolute value abs(dispₙ) of the transform coefficients according to embodiments.

Referring to FIG. 30, when the value of the isZero flag decoded by the isZero decoder is 1, abs(disp), the absolute value of the displacement vector transform coefficient, is set to 0. When the value of the flag is 0, the isOne flag is decoded by the isOne decoder. When the value of the isOne flag decoded by the isOne decoder is 1, abs(disp) is set to 1. When the value is 0, isK decoding is repeated up to K. When the value of the isK flag is 1, abs(disp) is set to K. Otherwise, disp_minus_Kplus1 decoding is performed, and abs(disp) is set to disp_minus Kplus1+K+1.

As described above, when the displacement vector transform coefficients are zero run-length decoded per LoD or sLoD by the transmission device, the second embodiment of the method of decoding the displacement vector by the displacement vector transform coefficient decoder 15017 may perform zero run-length decoding per LoD or sLoD level. In this case, the displacement vector transform coefficient decoder 15017 may know whether sLoD is enabled from the sLoD_enable_flag flag included in the signaling information, and may derive the number of vertices corresponding to each level based on the levels defined for the LoDs or sLoDs determined by the mesh subdivider 15015. In addition, in performing zero run-length decoding per LoD or sLOD level, transform coefficients may be decoded per LoD or sLoD level based on the derived number of vertices per LoD or sLoD level. Then, the mesh scalable function may be performed by reconstructing the displacement vector transform coefficients up to a specific LoD or sLoD level among the LoD or sLoD level-specific substreams.

### Third Embodiment of Displacement Vector Decoding Method

As described above, the displacement vector encoder on the transmitting side may perform zero run-length encoding by bundling the displacement vector transform coefficients of multiple frames in the GOF. In particular, if the vertices in the frames being grouped have a 1-to-1 mapping relationship, the displacement vector transform coefficients having the same vertex index may be packed in an interleaving manner. Otherwise, the displacement vector transform coefficients may be packed in a serial manner. Then, the signaling information (e.g., displacement_packing_method) is used to signal the packing method. In addition, the displacement vector encoder on the transmitting side may perform zero run-length encoding by bundling the displacement vector transform coefficients of the frames on a per-LoD or per-sLoD basis. Alternatively, the displacement vector encoder on the transmitting side may perform zero run-length coding per LoD (or sLoD) level for LoDs (or sLoDs) 0 to k, and perform zero run-length coding once for LoD (or sLoD) level k+1 to the last LoD (or sLoD) level.

In this case, the displacement vector transform coefficient decoder 15017 on the receiving side may also perform zero run-length decoding by bundling the displacement vector transform coefficients of multiple frames in the GOF.

In the case where the displacement vector encoder on the transmitting side has performed zero run-length encoding by interleaving the transform coefficients of the T (0, 1, . . . , T−1) frames in the GoF as shown in FIG. 21 or packing the coefficients serially as shown in FIG. 22, the displacement vector transform coefficient decoder 15017 on the receiving side may perform zero run-length decoding on the transform coefficients of the T (0, 1, . . . , T−1) frames in the GoF using the same packing method.

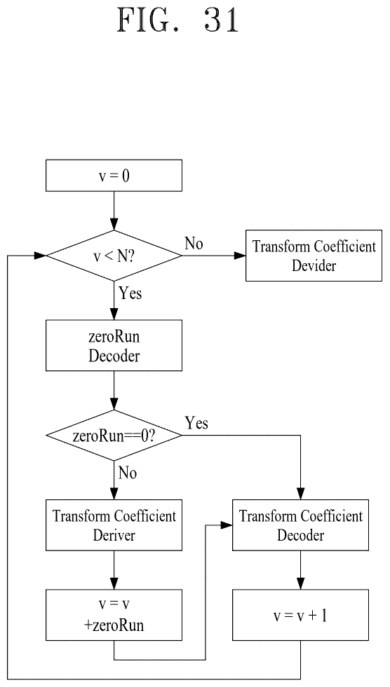

FIG. 31 is a flowchart illustrating an example method of decoding transform coefficients of multiple frames according to embodiments. That is, the figure illustrates an example of a decoding method performed by a displacement vector transform coefficient decoder on the receiving side when the transform coefficients of multiple frames have been packed and encoded by a displacement vector encoder on the transmitting side.

Referring to FIG. 31, a zeroRun decoder, a transform coefficient deriver, and a transform coefficient decoder are used to perform zeroRun decoding on

$$N = {\sum }_{f = 0}^{T - 1} numVertex [ f ]$$

transform coefficients. For example, when the value of zeroRun parsed by the zeroRun decoder is not 0, the transform coefficient deriver derives the values of the transform coefficients for vertices corresponding to the size of the parsed zeroRun to be 0. The transform coefficient decoder decodes the transform coefficients when the value of the parsed zeroRun is 0 or when the value of the zeroRun is derived to be 0.

Then, after restoring all the transform coefficients, the transform coefficient divider may divide the division coefficients according to a transform coefficient packing method (interleaving or serial packing) to restore the transform coefficients of each frame.

According to embodiments, the displacement vector transform coefficient decoder 15017 may perform zero run-length decoding per LoD (or sLoD) level by bundling the transform coefficients of multiple frames by LoD (or sLoD) level (in an interleaving or serial manner).

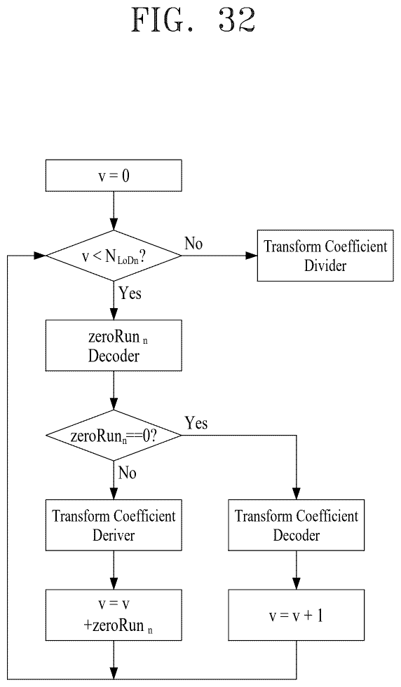

FIG. 32 is a flowchart illustrating another example method of decoding transform coefficients of multiple frames according to embodiments. Specifically, the figure illustrates an example method of decoding and unpacking such that when transform coefficients of multiple frames of a specific LoD (or sLoD) level by a displacement vector transform coefficient decoder on the receiving side when the transform coefficients of multiple frames of the same LoD (or sLoD) level are packed and encoded by a displacement vector encoder on the transmitting side.

Referring to FIG. 32, When the sum of the vertices of LoD n of multiple frames is

$${N}_{LoDn} = {\sum }_{f = 0}^{T - 1} {N}_{{Lod}_{n}}^{f} ,$$

zero run-length decoding may be performed on the transform coefficients in units of NLoDn, using the zeroRun decoder, the transform coefficient deriver, and the transform coefficients decoder.

Then, the zero run-length decoded transform coefficients at each level (NLoDn) may be divided on a frame-by-frame basis according to

$${N}_{{Lod}_{n}}^{f} .$$

the number of transform coefficients at the n-th LoD level of each frame, using the transform coefficient divider. Here,

$${N}_{{Lod}_{n}}^{f}$$

may be implicitly determined by the mesh subdivider 15015 based on the number of base meshes, where the level may be an sLoD level or a LoD level.

According to embodiments, a level (sLoD) for scalable support may be defined separately from the LoD level determined by the mesh subdivider 15015, and displacement vector transform coefficients may be decoded on a per-level basis. Then, the mesh scalable function may be performed by restoring the displacement vector transform coefficients up to a specific LoD (or sLoD) level of the LoD (or sLoD) levels.

As described above, the displacement vector transform coefficient decoder 15017 decodes the transform coefficients by applying at least one of the first to third embodiments of the displacement vector decoding method. The decoding may be performed by applying a 2D video codec, or may be performed by applying a zero run-length method. Further, scalable decoding may be performed only on the transform coefficients of a specific LoD level or sLoD level.

According to embodiments, the transform coefficients decoded by the displacement vector transform coefficient decoder 15017 are provided to the displacement vector inverse transformer 15018.

The displacement vector inverse transformer 15018 performs an inverse transform corresponding to the transform performed by the encoder of the transmission device. According to embodiments, a lifting inverse transform, a wavelet inverse transform, or the like may be performed.

For example, suppose that the lifting transform is performed by the encoder of the transmission device. In this case, in predicting the vertex Rx of the k-th subdivision level, the displacement vector of the k-th subdivision level may be performed using a subdivision vertex displacement vector of Rt (t<k or t<=k) as a predictor. According to embodiments, in predicting a displacement vector, an average or distance-based weighted average of the n nearest points based on connectivity information among vertices at a lower subdivision level than the current vertex may be predicted. According to embodiments, the prediction may be performed based on the displacement vectors of the n vertices used to generate the current vertex in the mesh subdivision step.

Then, when the lifting inverse transform is performed by the displacement vector inverse transformer 15018, the parsed residual signal may be used to update the displacement vectors of the vertices used by the encoder for prediction.

According to embodiments, the displacement vector inverse quantizer 15019 may inversely quantize the inversely transformed displacement vector, i.e., the displacement vector transform coefficients.

According to embodiments, the encoder of the transmission device may quantize the transform coefficients through different quantization parameters for the respective axes, and the quantization rate may be determined for each LoD level by deriving the quantization parameters or scaling parameters by an agreement made by the encoder/decoder.

According to embodiments, when the reconstructed displacement vector has values in the normal coordinate system (n, t, bt), the displacement vector coordinate inverse transformer 15020 may inversely transform the same to the Cartesian coordinate system (x, y, z).

In other words, the encoder of the transmission device may transform the vertex displacement vector calculated in the (x,y,z) space to the (normal, tangential, bi-tangential) coordinate system (also referred to as a normal coordinate system) based on the normal vector of each vertex. Here, the normal vector may be calculated for each subdivided vertex based on geometry information and connectivity information about neighboring vertices.

According to embodiments, a unit that includes the vector inverse transformer 15018, the displacement vector inverse quantizer 15019, and the displacement vector coordinate inverse transformer 15020 may be referred to as a displacement vector reconstructor. That is, when the displacement vector transform coefficients decoded by the displacement vector transform coefficient decoder 15017 is processed through the displacement vector reconstructor, a final reconstructed displacement vector may be generated. In the case where the displacement vector transform coefficient decoder 15017 performs scalable decoding (e.g., 2D video decoding or zero run-length decoding) only on transform coefficients of a specific LoD level or sLoD level, the final reconstructed displacement vector is a displacement vector of the specific LoD level or sLOD level.

According to embodiments, the received and demultiplexed texture map bitstream is input to the texture map decoder 15021. According to embodiments, the texture map decoder 15021 may decode the texture map configured per specific LoD level or sLoD level using a 2D scalable decoder. In the present disclosure, the LoD level is determined by the mesh subdivider 15015, and the sLoD level may be defined by an agreement made by the encoder/decoder based on the LoD level for scalable decoding, or may be configured through information received. In other words, the texture map decoder 15021 may apply 2D scalable decoding to the texture map configured per LoD level or sLoD level to reconstruct the texture map. To this end, the texture map decoder 15021 may be provided with information related to subdivision performed by the mesh subdivider 15015, LoD-related information, and/or sLoD-related information as signaling information. Further, the texture map encoder 15021 may be provided with LoD-related information and/or sLoD-related information applied to the displacement vector scalable decoding, which is performed by the displacement vector decoder 15017, as signaling information.

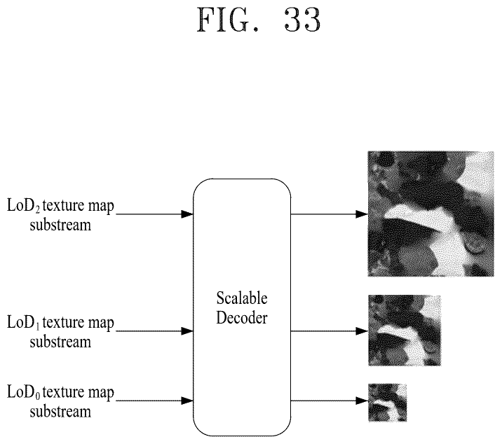

FIG. 33 is a diagram illustrating an example of scalable decoding of a texture map by a texture map decoder according to embodiments.

According to embodiments, the level-specific texture maps may be decoded by the texture map decoder 15021 by parsing a sub-bitstream starting with a texture map of a lower LoD. The texture map decoding may be performed by inter-layer (level) references that refer to a texture map of a lower level than the current level.

Then, the mesh scalable function may be performed by decoding the texture maps up to a specific level among the level-specific texture map substreams. Here, the level may be a LoD level or an sLoD level. To this end, the texture map decoder 15021 may include as many scalable decoders as the LoD levels or sLoD levels. For example, the texture map decoder 15021 may perform decoding only on the texture map substream corresponding to the LoD0 level, may perform decoding only on the texture map substream corresponding to the LoD1 level, or may perform decoding only on the texture map substream corresponding to the LoD2 level.

According to embodiments, the mesh reconstructor 15016 may generate a final reconstructed mesh by combining (i.e., adding) the reconstructed base mesh subdivided by the mesh subdivider 15015 with the displacement vectors reconstructed by the displacement vector reconstructor. In this case, when the displacement vectors reconstructed by the displacement vector reconstructor are displacement vectors up to a specific LoD level or sLOD level, the mesh reconstructed by the mesh reconstructor 15016 may also be a mesh up to the specific LoD level or sLoD level. In other words, the mesh reconstructor 15016 may reconstruct the mesh on a per-LoD level or per-sLoD level basis, and the mesh reconstructed on the per-LoD level or per-sLoD level basis may have reconstructed vertices, vertex connectivity information, texture coordinates, and texture coordinate connectivity information.

As such, when scalable decoding is performed by the displacement vector transform coefficient decoder 15017 to reconstruct the displacement vector of a specific level (e.g., LoD level or sLoD level), the mesh subdivider 15015 performs subdivision up to the level (e.g., LoD level or sLoD level). Then, by adding the reconstructed displacement vectors for the level (e.g., LoD level or sLoD level) to the base mesh subdivided up to the level and applying the reconstructed texture map for the level to the result of the addition, a final reconstructed mesh for the level may be constructed.

In this case, when the texture coordinates of the reconstructed mesh are not normalized values between 0 and 1, the mesh reconstructor 15016 may perform normalization to values between 0 and 1 based on W and H of the original texture map and Wₙ and Hₙ of the texture map to be reconstructed, or may perform scaling to (u, v), where 0≤u≤Wₙ and 0≤v≤Hₙ.

According to embodiments, when scaling is performed on the texture coordinates having a range of 0≤u≤W, 0≤v≤H with a reconstructed texture map (Wₙ×Hₙ), the u, v coordinates may be calculated with Equation 3 below.

$$( u , v ) = ( u * \frac{{W}_{n}}{W} , v * \frac{{H}_{n}}{H} ) \qquad [ Equation 3 ]$$

As such, the texture map decoder 15021 may decode the texture map bitstream of the specific LoD level or sLoD level using the video codec to reconstruct the texture map up to the specific LoD level or sLoD level. The reconstructed texture map has color information about each vertex contained in the reconstructed mesh, and the color value of each vertex may be obtained from the texture map based on the texture coordinates of each vertex.

According to embodiments, the reconstructed mesh from the mesh reconstructor 15016 and the reconstructed texture map from the texture map video decoder 15021 are presented to the user through a rendering process performed by a mesh data renderer (not shown). In one embodiment, when it is assumed that scalable decoding has been applied to the reconstructed mesh and the reconstructed texture map being rendered, the same LoD level or sLoD level may be applied.

As described above, signaling information is needed to allow the encoder of the transmission device to scalably encode the displacement vectors and texture maps per LoD level or sLoD level and to allow the decoder of the reception device to scalably decode the displacement vectors and texture maps encoded per LoD level or sLoD level. The signaling information is also needed to allow the encoder of the transmission device to perform 2D video encoding or zero run-length encoding on the displacement vectors per LoD level or sLoD level and to allow the decoder of the reception device to perform 2D video decoding or zero run-length decoding on the displacement vectors encoded per LoD level or sLoD level.

In the present disclosure, in the transmission device, the signaling information may be generated by an auxiliary information generator (not shown) in the transmission device and provided to the corresponding blocks in the transmission device and/or to the reception device, and an auxiliary information decoder (not shown) in the reception device may parse the received signaling information and provide the same to the corresponding blocks.

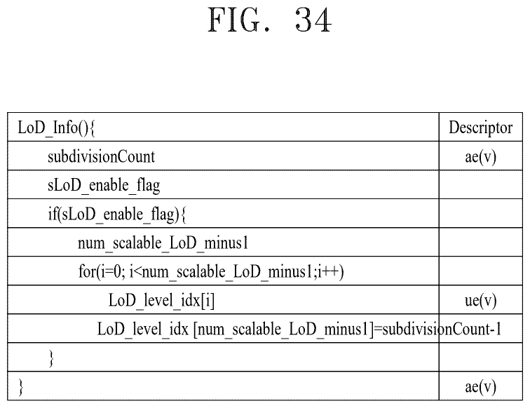

FIGS. 34 to 37 show example syntax structures of signaling information related to the present disclosure.

FIG. 34 shows an example syntax structure of LoD-related information (LoD_Info ( ) in signaling information according to embodiments.

According to embodiments, the LoD-related information (LoD_Info ( ) may include a subdivisionCount field and an sLoD_enable_flag field. Further, depending on the value of the sLoD_enable_flag field, the LoD-related information (LoD_Info ( ) may further include a num_scalable LoD_minus1 field.

The subdivisionCount field is an index indicating the number of times the subdivision will be performed by the mesh subdivider. In other words, the subdivisionCount field indicates the number of LoD levels.

The sLoD_enable_flag field is a flag that determines whether the level (sLoD) is parsed to perform scalable decoding on the receiving side. For example, the sLoD_enable_flag field set to 1 indicates that the encoder of the transmission device has encoded the displacement vector transform coefficients on an sLoD basis, and the sLoD_enable_flag field set to 0 indicates that the encoder has encoded the coefficients on a LoD basis. Therefore, the decoder of the reception device decodes the displacement vector transform coefficients based on the sLoD when the value of the sLoD_enable_flag field is 1, and based on LoD when the value of the sLoD_enable_flag field is 0. For example, when the value of the sLoD_enable_flag field is 0, the mesh subdivision may perform encoding/decoding using the LoD level determined by subdivisionCount.

In the present disclosure, when the value of the sLOD_enable_flag field is 1, the LoD-related information (LoD_Info ( ) may further include a num_scalable_LoD_minus1 field.

The num_scalable_LoD_minus1 field indicates the number of sLoD levels minus 1. That is, the num_scalable_LoD_minus1 field is information for identifying the number of sLoD levels.

According to embodiments, the LoD-related information (LoD_Info ( ) may further include a loop that iterates as many times as the value of the num_scalable_LoD_minus1 field. In one embodiment, i may be initialized to 0, incremented by 1 each time the loop is executed. The loop may iterate until the value of i equals the value of the num_scalable_LoD_minus1 field. The loop may include a LoD level_idx[i] field and a LoD level_idx

$$[ num\_scalable \_LoD \_minus1 ] = subdivisionCount - 1 field .$$

The LoD_level_idx [i] field indicates the index of the LoD level corresponding to the i-th sLoD level. That is, the LoD_level_idx [i] field is the index of the LoD level corresponding to each sLoD level.

When the LoD is composed of N levels in the mesh subdivider and the value of the num_scalable_LoD_minus1 field is k−1, the reception device may implicitly derive the k−1-th LoD_level_idx as N−1.

LoD_level_idx [num_scalable_LoD_minus1]=subdivisionCount−1 indicates that the LoD_level_idx of the i-th sLOD level is set based on information related to the number of LoD levels (subdivisionCount−1).

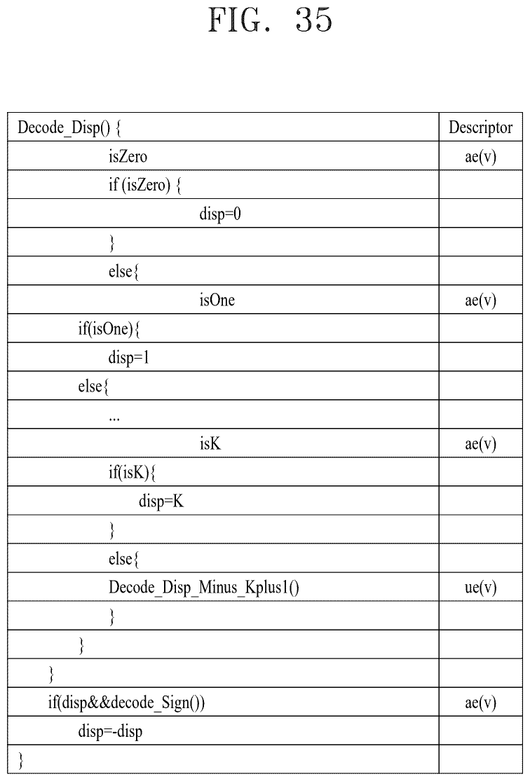

FIG. 35 shows an example syntax structure of displacement vector decoding related information (Decode_Disp ( ) in signaling information according to embodiments.

According to embodiments, the displacement vector decoding related information (Decode_Disp ( ) may include an isZero flag, an isOne flag, and an isk flag.

The isZero flag indicates the number of consecutive 0-bits. The isZero flag is set to 0 or a positive integer. When the isK flag is set to 1 and the value of the next bit is 0, the isZero flag is set to a value representing the number of consecutive 0's. This is used to compress the sequence of 0's.

Also, the isOne flag indicates the number of consecutive 1-bits. The isOne flag is also set to zero or a positive integer. When the isK flag is set to 1 and the value of the next bit is 1, the isOne flag is set to a value representing the number of consecutive 1's. This is used to compress the sequence of 1's.

The isK flag (Is-Known Flag) indicates when the value of the next bit is. This isK flag is set to either 1 or 0. When set to 1, it indicates the next bit value is a known value. For example, in the case of consecutive zeros, the isK flag is set to 1, and the value of the next bit is set to the known value, 0.

In FIG. 35, the group including isZero, isOne, and isK are referred to as isN. That is, isN may include isZero, isOne, . . . , and isK. In other words, isN is a flag that determines whether the magnitude of the transform coefficient (abs(disp)) is equal to N.

The magnitude of the transform coefficient (abs(disp)) may be determined as follows.

$$abs ( disp ) == N ? isN = 1 : isN = 0$$

In other words, in FIG. 35, when the value of the isZero flag is true (i.e., 0), the displacement transformation vector coefficient (disp) is 0. Otherwise, the value of the isOne flag is checked. When the value of the isOne flag is true (i.e., 1), the displacement transformation vector coefficient (disp) is 1. Also, when the value of the isOne flag is not true, the value of the isK flag is checked to see when it is true. When the value of the isK flag is true (i.e., K), the displacement transformation vector coefficient (disp) is equal to K. When the value of the isk flag is not true, the displacement transformation vector coefficient (disp) is determined by the value contained in Decode_Disp_Munus_Kplus1 ( )

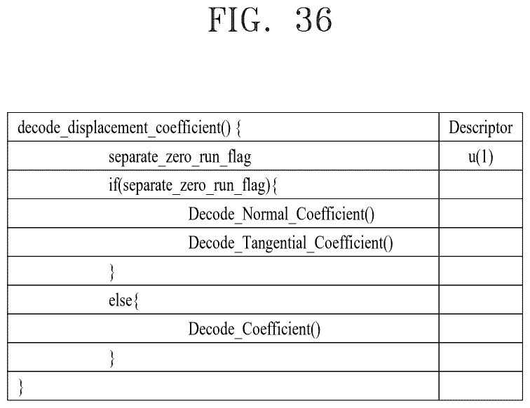

FIG. 36 shows an example syntax structure of information related to decoding of displacement vector transform coefficients (decode_displacement_coefficient ( ) in signaling information according to embodiments.

According to embodiments, the information related to decoding of the displacement vector transform coefficient (decode_displacement_coefficient ( ) may include a separate_zero_run_flag field.

When the coordinate system of the displacement vector is the normal coordinate system, the separate_zero_run_flag field may indicate whether to perform zero run-length encoding on the normal component (n) and the tangential components (t, bt) separately. In other words, the separate_zero_run_flag field is a flag that determines whether to perform zero run-length decoding on the normal component and the tangential components separately. For example, the separate_zero_run_flag field set to 1 indicates that the normal and tangential components are separately zero run-length encoded, while the separate_zero_run_flag field set to 0 indicates that the normal and tangential components are zero run-length encoded at once. In this case, the reception device or decoder may perform zero run-length decoding on the normal and tangential components separately when the value of the separate_zero_run_flag field is 1, and may perform zero run-length decoding for the normal and tangential components at once when the value of the separate_zero_run_flag field is 0.

Therefore, the information about decoding of the displacement vector transform coefficients (decode_displacement_coefficient ( ) may include Decode_Normal_Coefficient ( ) and Decode_Tangential_Coefficient ( ) when the value of the separate_zero_run_flag field is 1, and may include Decode_Coefficient ( ) when the value of the separate_zero_run_flag field is 0.

Decode_Normal_Coefficient ( ) may contain displacement vector transform coefficients related to the normal component, and Decode_Tangential_Coefficient ( ) may contain displacement vector transform coefficients related to the tangential components.

Decode_Coefficient ( ) may contain displacement vector transform coefficients related to the normal component and the tangential components.

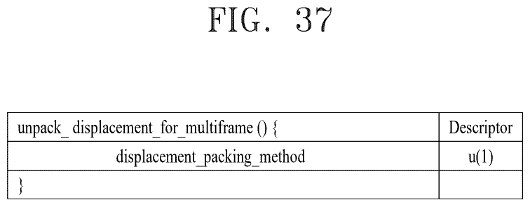

FIG. 37 shows an example syntax structure of packing related information for multiple frames (unpack_displacemenst_for_multiframe ( ) in signaling information according to embodiments.

According to embodiments, the packing related information for multiple frames (unpack_displacemenst_for_multiframe ( ) may include a displacement_packing_method field.

The displacement_packing_method field is an index indicating a method of packing the displacement vector transform coefficients of multiple frames should be packed when the displacement vector transform coefficients of multiple frames are encoded in a bundle. For example, the displacement_packing_method field set to 0 indicates that the frames are packed in an interleaving manner, while the displacement_packing_method field set to 1 indicates that the frames are packed in a serial manner.

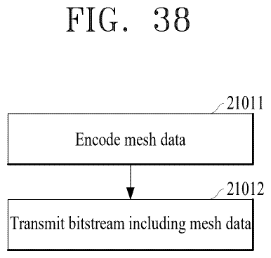

FIG. 38 is a flowchart illustrating an example transmission method according to embodiments. The transmission method according to the embodiments may include encoding mesh data (21011) and transmitting a bitstream containing the encoded mesh data (21012).

According to embodiments, the encoding of the mesh data (21011) may include defining LoD levels and/or sLoD levels when subdividing the base mesh, and performing displacement vector encoding and texture map encoding per LoD level or sLoD level. The displacement vector encoding may be performed using a conventional 2D video codec, or may be performed using a zero run-length coder. For details of 2D video encoding or zero run-length encoding of displacement vectors per LoD level or sLoD level and 2D video encoding of texture maps per LoD level or sLOD level, which are not described below to avoid redundancy, refer to the description of FIGS. 15 to 25. Also, for details of 2D video encoding or zero run-length encoding of displacement vectors per LoD level or sLoD level and signaling information for 2D video encoding of texture maps per LoD level or sLoD level, which are not described below to avoid redundancy, refer to the description of FIGS. 34 to 37.

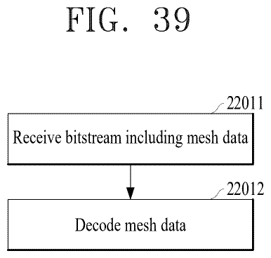

FIG. 39 is a flowchart illustrating an example reception method according to embodiments. The reception method according to the embodiments may include receiving a bitstream containing mesh data (22011) and decoding the mesh data contained in the bitstream (22012).

In the present disclosure, the decoding of the mesh data contained in the bitstream (22012) may include performing displacement vector decoding and texture map decoding per LoD level or sLoD level based on signaling information for the demultiplexed displacement vector bitstream and texture map bitstream. The displacement vector decoding may be performed using a conventional 2D video codec or a zero run-length decoder. For details of 2D video decoding or zero run-length decoding of the displacement vectors per LoD level or sLoD level and 2D video decoding of the texture map per LoD level or sLOD level, which are not described below to avoid redundancy, refer to the description of FIGS. 15 to 33. Also, for details of 2D video decoding or zero run-length decoding of displacement vectors per LoD level or sLOD level and signaling information for 2D video decoding of texture maps per LoD level or sLOD level, which are not described below to avoid redundancy, refer to the description of FIGS. 34 to 37.

As such, since the existing V-Mesh compression method is designed to compress and reconstruct the displacement vector video and texture map video generated during the encoding process using a video codec based on the overall resolution, the received mesh data may not be used when it is difficult to receive and utilize the entire mesh data depending on the conditions of the receiver. To address this issue, a scalable mesh encoding method for a transmission device and a scalable mesh decoding method for a reception device are proposed such that the mesh may be selectively reconstructed and utilized on the receiving side. In particular, the present disclosure proposes a method for scalable encoding (on the transmitting side) and scalable decoding (on the receiving side) of displacement vector video and texture map video, method of encoding and decoding displacement vector transform coefficients with improved performance, and a method of performing scalable encoding and decoding based on the displacement vector transform coefficients. Thus, the present disclosure may enable a user to selectively reconstruct mesh data based on mesh subdivision levels up to an available level depending on the performance or display characteristics of the receiver and the network environment. In addition, when multiple mesh data objects are to be represented, the user may be allowed to specify different levels of detail and level of mesh data to be reconstructed depending on the importance, frequency of use, and current status of use of the objects, and reconstruct each object according to the desired level. Thereby, the given resources may be appropriately distributed and used efficiently. Thus, the present disclosure may enable mesh data to be utilized in a wider variety of network environments and applications, and further expand the scope of utilization of mesh data by enabling flexible use of the resources of the receiver.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

In the specification, when a part “comprises” or “includes” an element, it means that the part further comprises or includes another element unless otherwise mentioned. Also, the term “ . . . module (or unit)” disclosed in the specification means a unit for processing at least one function or operation, and may be implemented by hardware, software or combination of hardware and software.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments of the embodiments have been shown and described, the embodiments are not limited to the specific embodiments described above, and various modifications may be made by one of ordinary skill in the art without departing from the spirit of the embodiments claimed in the claims, and such modifications should not be understood in isolation from the technical ideas or views of the embodiments.

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted to indicate “and/or.” For instance, the expression “A/B” may mean “A and/or B.” Further, “A, β” may mean “A and/or B.” Further, “A/B/C” may mean “at least one of A, β, and/or C.” Also, “A/B/C” may mean “at least one of A, β, and/or C.” Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

Various elements of the embodiments may be implemented by hardware, software, firmware, or a combination thereof. Various elements in the embodiments may be executed by a single chip such as a single hardware circuit. According to embodiments, the element may be selectively executed by separate chips, respectively. According to embodiments, at least one of the elements of the embodiments may be executed in one or more processors including instructions for performing operations according to the embodiments.

Operations according to the embodiments described in this specification may be performed by a transmission/reception device including one or more memories and/or one or more processors according to embodiments. The one or more memories may store programs for processing/controlling the operations according to the embodiments, and the one or more processors may control various operations described in this specification. The one or more processors may be referred to as a controller or the like. In embodiments, operations may be performed by firmware, software, and/or combinations thereof. The firmware, software, and/or combinations thereof may be stored in the processor or the memory.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise. The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components.

As used herein, conditional expressions such as “if” and “when” are not limited to an optional case and are intended to be interpreted, when a specific condition is satisfied, to perform the related operation or interpret the related definition according to the specific condition. Embodiments may include variations/modifications within the scope of the claims and their equivalents. It will be apparent to those skilled in the art that various modifications and variations can be made in the present disclosure without departing from the spirit and scope of the disclosure. Thus, it is intended that the present disclosure cover the modifications and variations of this disclosure provided they come within the scope of the appended claims and their equivalents.

### MODE FOR DISCLOSURE

As described above, related contents have been described in the best mode for carrying out the embodiments.

### INDUSTRIAL APPLICABILITY

As described above, the embodiments may be fully or partially applied to the 3D data transmission/reception device and system. It will be apparent to those skilled in the art that various changes or modifications may be made to the embodiments within the scope of the embodiments. Thus, it is intended that the embodiments cover modifications and variations provided they come within the scope of the appended claims and their equivalents.

1. A method of three-dimensional (3D) data, the method comprising:
encoding original mesh data; and
transmitting a bitstream containing the encoded mesh data and signaling information.

2. The method of claim 1, wherein the encoding of the mesh data comprises:
generating base mesh data by decimating the original mesh data and encoding the base mesh data;
generating additional vertices by subdividing the decimated mesh data one or more times and determining one or more levels varying depending on the number of times of the subdivision;
reconstructing the encoded base mesh data;
generating displacement information based on the subdivided mesh data and the reconstructed base mesh data;
encoding the displacement information;
reconstructing the encoded displacement information;
reconstructing mesh data based on the reconstructed base mesh data and the reconstructed displacement information;
regenerating a texture map based on a texture map of the original mesh data and the reconstructed mesh data; and
encoding the regenerated texture map.

3. The method of claim 2, wherein the encoding of the displacement information comprises:
encoding the displacement information corresponding to at least one of the one or more levels using a 2D video codec.

4. The method of claim 2, wherein the encoding of the displacement information comprises:
encoding the displacement information corresponding to at least one of the one or more levels using a zero run-length coding.

5. The method of claim 2, wherein the encoding of the displacement information comprises:
packaging the displacement information in a plurality of frames corresponding to at least one of the one or more levels; and
encoding the packaged displacement information using a zero run-length coding.

6. The method of claim 5, wherein the displacement information in the plurality of frames is packaged using an interleaving method or a serial method based on a mapping relationship of vertices between the plurality of the frames.

7. The method of claim 5, wherein the signaling information comprises information related to the one or more levels or information related to the packaging of the displacement information in the plurality of frames.

8. The method of claim 2, wherein the one or more levels are at least one level of detail (LoD) or at least one scalable LoD (sLoD).

9. The method of claim 8, wherein the at least one sLoD is configured based on the at least one LoD,
wherein a specific sLoD in the at least one sLoD is mapped to one of the at least one LoD.

10. The method of claim 9, wherein the number of levels in the at least one sLoD is different from the number of levels in the at least one LoD.

11. The method of claim 2, wherein the encoding of the texture map comprises:
encoding the texture map corresponding to at least one of the one or more levels using a 2D video codec.

12. A device for transmitting three-dimensional (3D) data, comprising:
an encoder configured to encode original mesh data, and
a transmitter configured to transmit a bitstream containing the encoded mesh data and signaling information.

13. The device of claim 12, wherein the encoder comprises:
a base mesh compressor configured to generate base mesh data by decimating the original mesh data and to encode the base mesh data;
a mesh subdivider configured to generate additional vertices by subdividing the decimated mesh data one or more times and to determine one or more levels varying depending on the number of times of the subdivision;
a base mesh reconstructor configured to reconstruct the encoded base mesh data;
a displacement information generator configured to generate displacement information based on the subdivided mesh data and the reconstructed base mesh data;
a displacement information encoder configured to encode the displacement information;
a displacement information reconstructor configured to reconstruct the encoded displacement information;
a mesh reconstructor configured to reconstruct mesh data based on the reconstructed base mesh data and the reconstructed displacement information;
a texture map generator configured to regenerate a texture map based on a texture map of the original mesh data and the reconstructed mesh data; and
a texture map generator configured to encode the regenerated texture map.

14. A method of receiving three-dimensional (3D) data, the method comprising:
receiving a bitstream containing encoded mesh data and signaling information;
decoding the encoded mesh data in the bitstream based on the signaling information; and
rendering the decoded mesh data.

15. The method of claim 14, wherein the decoding of the mesh data comprises:
reconstructing base mesh data from the encoded mesh data;
generating additional vertices by subdividing the reconstructed base mesh data one or more times and determining one or more levels based on the signaling information and the number of times of the subdivision;
decoding and reconstructing displacement information from the encoded mesh data;
reconstructing mesh data based on the subdivided base mesh data and the reconstructed displacement information;
decoding and reconstructing a texture map from the encoded mesh data; and
performing rendering based on the reconstructed mesh data and the reconstructed texture map.
